(19) United States
(12) Patent Application Publication
(10) Pub. No.: US 2026/0303289 A1
(43) Pub. Date: Oct. 1, 2026

(54) ENHANCED SPATIAL DOMAIN BASIS REPORTING FOR NEAR FIELD CHANNEL STATE INFORMATION

(71) Applicant: InterDigital Patent Holdings, Inc., Wilmington, DE (US)

(72) Inventors: Patrick Svedman, Stockholm (SE); Afshin Haghighat, Ile-Bizard (CA); Jyotish Robin, New York, NY (US); Salah Elhoushy, LaSalle (CA); Chia-Hung Wei, Chesterbrook, PA (US); Yifan Li, Conshohocken, PA (US); Allan Yingming Tsai, Boonton, NJ (US); Ravikumar Pragada, Warrington, PA (US)

(73) Assignee: InterDigital Patent Holdings, Inc., Wilmington, DE (US)

(21) Appl. No.: 19/092,037

(22) Filed: Mar. 27, 2025

(51) Int. Cl. H04L 5/00

(52) U.S. Cl. CPC H04L 5/0051

(57) ABSTRACT

Mechanisms for reducing the reporting overhead corresponding to spatial domain (SD) basis reporting facilitate reporting of different beams (SD bases) for the different panels, with reduced reporting overhead, compared to independent per panel reporting. For multi-panel precoder reporting, a WTRU may report the SD basis (beam) for a reference panel (reference CSI-RS). For non-reference panels (non-reference CSI-RS), the WTRU may report beam offsets in relation to the beam of the reference panel. The WTRU may determine and report beam offset parameters, e.g., step size and range, based on measurements, e.g., distance. For multi-beam reporting, the multiple beam offsets for a non-reference panel may be associated with the multiple beams by the ordinal positions of the beam offsets in the CSI report.

### BACKGROUND

With increasing numbers of transmission/reception point (TRP) antenna array apertures and carrier frequencies, the classical planar wave approximation no longer holds in an increasing part of the coverage area, called the near field (NF). In contrast, the planar wave approximation is valid in what is called the far field (FF). Legacy direction-based far-field beamforming, however, suffers a loss in beamforming gain in the near field.

Current systems support multi-panel channel state information (CSI) acquisition. Current systems support a variety of codebooks for CSI acquisition. In type I codebooks, the precoder for a layer corresponds to a single path, whereas in type II codebooks, multiple paths are included in the precoder. A multi-panel type I codebook was introduced, wherein a single spatial domain basis was selected by the UE and applied to each panel. The multi-panel precoder (or precoding matrix indicator (PMI) was determined based on a single CSI reference signal (CSI-RS) resource for channel measurement, with up to 32 antenna ports. Improvements lead to CSI acquisition based on up to 128 antenna ports, including a multi-panel type I codebook for up to 128 antenna ports. The increased number of antenna ports was achieved without increasing the maximum number of antenna ports per CSI-RS resource (e.g., 32), but by aggregating the ports from multiple, up to 4, CSI-RS resources. For the multi-panel codebook based on up to 4 CSI-RS resources, each CSI-RS resource may correspond to a panel. For each of the CSI-RS resources, the UE may determine a PMI based on a single-panel type I codebook. The SD basis may be selected independently between the different PMIs that correspond to the different CSI-RS resources.

In an array comprising multiple panels deployed on a structure, e.g., a wall or similar, the structure may be planar, or approximately planar, such that multiple panels may be seen as mounted on a plane. A user equipment (UE) may be in the near field of the multi-panel array, but in the far field of each panel. In state-of-the-art CSI reporting, a spatial domain (SD) basis is selected for each panel. In one design, the same SD basis is selected for each panel, which may be appropriate if the UE is in the far field of the TRP. In another design, the SD basis is selected independently for each panel, which gives the high flexibility, but also high reporting overhead of the SD basis.

### SUMMARY

Mechanisms for reducing the reporting overhead corresponding to spatial domain (SD) basis reporting are described herein. The herein described mechanisms may enable reporting of different beams (SD bases) for the different panels, with reduced reporting overhead, compared to independent per panel reporting. Mechanisms are described herein for reporting type I multi-panel CSI, while also enabling reporting of different SD basis for different panels, for a UE in the near field. A UE also is referred to herein as a wireless transmit/receive unit (WTRU).

The directions from the panels to the near-field WTRU (for a path) are correlated. Depending on the locations of the panels in the TRP array, an angular relation between the directions from the panels to the WTRU have a particular structure. For example, the directional angles gradually increase when moving from a panel on one edge of the array to a panel on the opposite edge of the array. Since existing (FF) codebooks generally are structured so that adjacent codewords (beams) correspond to adjacent angles, differential beam reporting (from the codebook) between resources, such as, for example, channel state information references signal (CSI-RS) resources, that correspond to adjacent panels can reduce the reporting overhead.

As described herein, for multi-panel precoder reporting, a WTRU may report the spatial domain (SD) basis (beam) for a reference panel (reference resource, or reference CSI-RS). For non-reference panels (non-reference resource, or non-reference CSI-RS), the WTRU may report beam offsets in relation to the beam of the reference panel. The WTRU may determine and report beam offset parameters, e.g., step size and range, based on measurements, e.g., distance. For multi-beam reporting, the multiple beam offsets for a non-reference panel are associated with the multiple beams by the ordinal positions of the beam offsets in the report (e.g., CSI report).

An example WTRU may comprise a transceiver and a processor. The processor may be configured to receive, via the transceiver, a configuration. The configuration may comprise a set of resources (e.g., CSI-RS resources, comprising a first resource (reference panel) configured as reference resource and a set of non-reference resources (panels). The configuration may comprise a codebook (e.g., single-panel type-l) for precoder reporting for each of the resources. The configuration may comprise a two-dimensional relation (2D-relation) between the resources (panels), e.g., the number of resources in the vertical direction. The configuration may comprise a set of beam offset step sizes for differential beam (SD basis) reporting.

The processor may be configured to determine a relationship between the resources (e.g., CSI-RS resources) by ordering them in a 2D grid, based on the configured resources and the configured 2D-relation. The processor may be configured to receive, via the transceiver, the set of resources. The processor may be configured to determine a beam offset step size from the set of beam offset step sizes. The processor may be configured to determine the beam offset step size from the set of beam offset step sizes, based on the received set of CSI-RS and/or based on a distance measurement. The processor may be configured to determine, based on the received resources, a first beam (SD basis) for the reference resource from the codebook. The processor may be configured to determine, based on the received resources, a beam for each of the non-reference resources from the codebook. To determine the vertical beam for a resource, the processor may be configured to determine a beam with an index equal to the beam determined for the resource below in the 2D grid, plus a beam offset, based on the determined vertical step size. To determine the horizontal beam for a resource, the processor may be configured to determine a beam with an index equal to the beam determined for the resource to the left in the 2D grid, plus a beam offset, based on the determined horizontal step size.

The processor may be configured to report, via the transceiver, the determined beams for the multiple resources. The report may comprise legacy beam indices in the vertical and horizontal directions for the reference resource. The report may comprise an indication of the determined beam offset step size(s). The report may comprise beam offsets in the vertical and horizontal directions for the non-reference resources.

An example WTRU may comprise a transceiver and a processor. The processor may be configured to receive, via the transceiver, configuration information. The configuration information may comprise an indication of a set of resources. The set of resources may comprise a reference resource and one or more non-reference resources. The configuration information may comprise at least one codebook associated with the set of resources. The configuration information may comprise a set of beam offset parameters for differential beam reporting. The processor may be configured to receive, via the transceiver, the set of resources. The processor may be configured to determine at least one set of beam offset values from the set of beam offset parameters. The processor may be configured to, based on the received set of resources, determine a reference beam for the received reference resource based on the received at least one codebook and determine respective non-reference beams for each of the non-reference resources based on the received at least one codebook. The processor may be configured to send, via the transceiver, a report. The report may comprise an indication of the reference beam comprising beam indices in a first dimension and a second dimension associated with the reference resource. The report may comprise respective beam offset values, based on the at least one set of beam offset values, in the first dimension and the second dimension for the received non-reference resources. The report may comprise an indication of respective beams for the non-reference resources based on beam indices associated with the reference resource and respective offset values.

The set of resources may comprise a set of channel state information reference signal (CSI-RS) resources. The reference resource may comprise a reference CSI-RS resource. The one or more non-reference resources may comprise one or more non-reference CSI-RS resources. The at least one codebook may comprise a first codebook associated with the reference resource and a second codebook associated with the non-reference resources. The processor may be configured to determine a reference beam for the received reference resource based on the first codebook. The processor may be configured to determine the respective non-reference beams for the received reference resource based on the second codebook.

The set of beam offset parameters may comprise a plurality of beam offset values and the processor may be configured to determine the at least one set of beam offset values based on the plurality of beam offset values.

The set of beam offset parameters may comprise a set of beam offset step sizes. The processor may be configured to determine a beam offset step size based on the set of beam offset step sizes. The processor may be configured to determine the at least one set of beam offset values based on the set of beam offset step sizes, wherein beam offset values are separated by the determined beam offset step size, The report may comprise an indication of the determined beam offset step size.

The set of beam offset parameters may comprise a plurality of sets of beam offset values. The processor may be configured to determine the at least one set of beam offset values based on the plurality of sets of beam offset values. The report may comprise an indication of the determined at least one set of beam offset values.

The at least one set of beam offset values may comprise a first set of beam offset values associated with the first dimension and a second set of beam offset values associated with the second dimension. The report may comprise respective beam offset values in the first dimension based on the first set of beam offset values and beam offset values in the second dimension based on the second set of beam offset values for the received non-reference resources.

The configuration information further may comprise a two-dimensional (2D) relationship between the received set of resources in the first dimension. The processor may be configured to order the received set of resources in a two-dimensional (2D) grid and determine a 2D relationship between the received set of resources based on the 2D grid. The processor may be configured to determine a beam in the first dimension for the reference resource and a beam in the first dimension for the non-reference resource.

An example method may be performed by a WTRU. The method may comprise receiving configuration information. The configuration information may comprise an indication of a set of resources. The set of resources may comprise a reference resource and one or more non-reference resources. The configuration information may comprise at least one codebook associated with the set of resources. The configuration information may comprise a set of beam offset parameters for differential beam reporting. The method may comprise receiving the set of resources. The method may comprise determining at least one set of beam offset values from the set of beam offset parameters. The method may comprise, based on the received set of resources, determining a reference beam for the received reference resource based on the received at least one codebook and determine respective non-reference beams for each of the non-reference resources based on the received at least one codebook. The method may comprise sending a report. The report may comprise an indication of the reference beam comprising beam indices in a first dimension and a second dimension associated with the reference resource. The report may comprise respective beam offset values, based on the at least one set of beam offset values, in the first dimension and the second dimension for the received non-reference resources. The report may comprise an indication of respective beams for the non-reference resources based on beam indices associated with the reference resource and respective offset values.

The set of resources may comprise a set of channel state information reference signal (CSI-RS) resources. The reference resource may comprise a reference CSI-RS resource. The one or more non-reference resources may comprise one or more non-reference CSI-RS resources. The at least one codebook may comprise a first codebook associated with the reference resource and a second codebook associated with the non-reference resources. The method may comprise determining a reference beam for the received reference resource based on the first codebook. The method may comprise determining the respective non-reference beams for the received reference resource based on the second codebook.

The set of beam offset parameters may comprise a plurality of beam offset values and the processor may be configured to determine the at least one set of beam offset values based on the plurality of beam offset values.

The set of beam offset parameters may comprise a set of beam offset step sizes. The method may comprise determining a beam offset step size based on the set of beam offset step sizes. The method may comprise determining the at least one set of beam offset values based on the set of beam offset step sizes, wherein beam offset values are separated by the determined beam offset step size, The report may comprise an indication of the determined beam offset step size.

The set of beam offset parameters may comprise a plurality of sets of beam offset values. The method may comprise determining the at least one set of beam offset values based on the plurality of sets of beam offset values. The report may comprise an indication of the determined at least one set of beam offset values.

The at least one set of beam offset values may comprise a first set of beam offset values associated with the first dimension and a second set of beam offset values associated with the second dimension. The report may comprise respective beam offset values in the first dimension based on the first set of beam offset values and beam offset values in the second dimension based on the second set of beam offset values for the received non-reference resources.

The configuration information further may comprise a two-dimensional (2D) relationship between the received set of resources in the first dimension. The method may comprise ordering the received set of resources in a two-dimensional (2D) grid and determine a 2D relationship between the received set of resources based on the 2D grid. The method may comprise determining a beam in the first dimension for the reference resource and a beam in the first dimension for the non-reference resource.

### BRIEF DESCRIPTION OF THE DRAWINGS

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 is an example illustration of an array comprising 8 panels mounted on a planar wall.

FIG. 3 is a an example illustration of a uniform linear array and a WTRU in the far field of the array.

FIG. 4 is an example illustration of angular relationships between beams in a codebook.

FIG. 5 is an illustration of beam angles from a uniform linear array (ULA). In FIG. 5(a), the antenna spacing is half a wavelength. In FIG. 5(b), the antenna spacing is ⅔ of a wavelength.

FIG. 6 is an example illustration of angles from panels to a WTRU for a line of sight (LoS) path.

FIG. 7 is an example illustration of angles from panels to a WTRU.

FIG. 8, illustrating FIG. 8(a) and FIG. 8(b), is a depiction of an example of the dependency between the panel-to-panel angle differences and the WTRU distance.

FIG. 9 is an example illustration of three sets (a), (b), and (c), of groups of channel state information reference signals (CSI-RSs).

FIG. 10 is an example illustration of relationships between a beam index for the reference channel state information reference signal (CSI-RS) in a dimension and the beam indices of non-reference CSI-RSs in the dimension. The relationship comprises the beam offsets in relation to the reference beam index.

FIG. 11 depicts an example illustration of relationships between the beam indices for the received CSI-RS in a dimension based on a one-dimensional relational chain, wherein the reference CSI-RS is in one end of the chain.

FIG. 12 is an example illustration of a mapping between CSI-RS and panels, wherein R denotes the panel from which the reference CSI-RS is transmitted, and a number n=1, . . . , 7 indicates the panel from which non-reference CSI-RS n is transmitted. The arrow points to a non-reference CSI-RS from the corresponding primary CSI-RS.

FIG. 13 is an example illustration of relations and beam offsets in a first dimension.

FIG. 14 is an example illustration of relations and beam offsets in a second dimension.

FIG. 15 is an example illustration of beam indices for 8 CSI-RSs, e.g., in a codebook.

FIG. 16 is an example illustration of beam indices for a reduced subset of CSI-RS.

FIG. 17 is an example illustration of reduced beam indices.

FIG. 18 is an example illustration of a determination of multiple (two) beams per CSI-RS.

### EXAMPLE NETWORKS FOR IMPLEMENTATION OF THE INVENTION

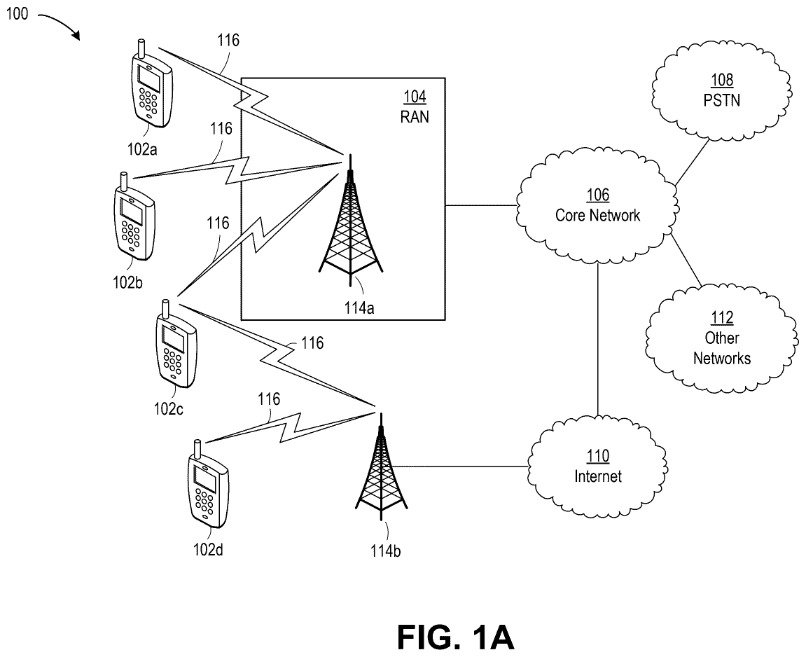

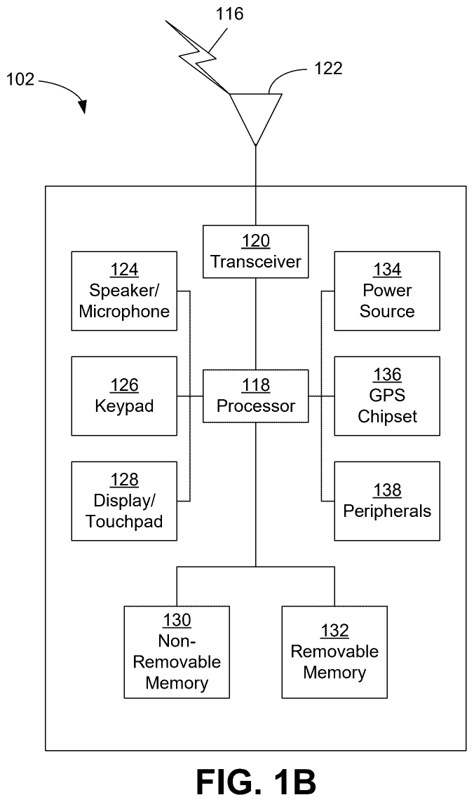

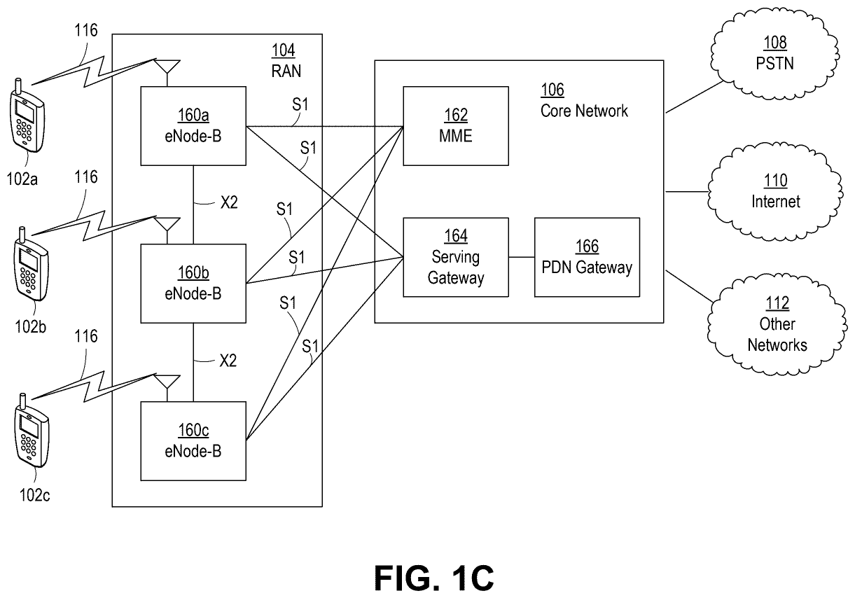

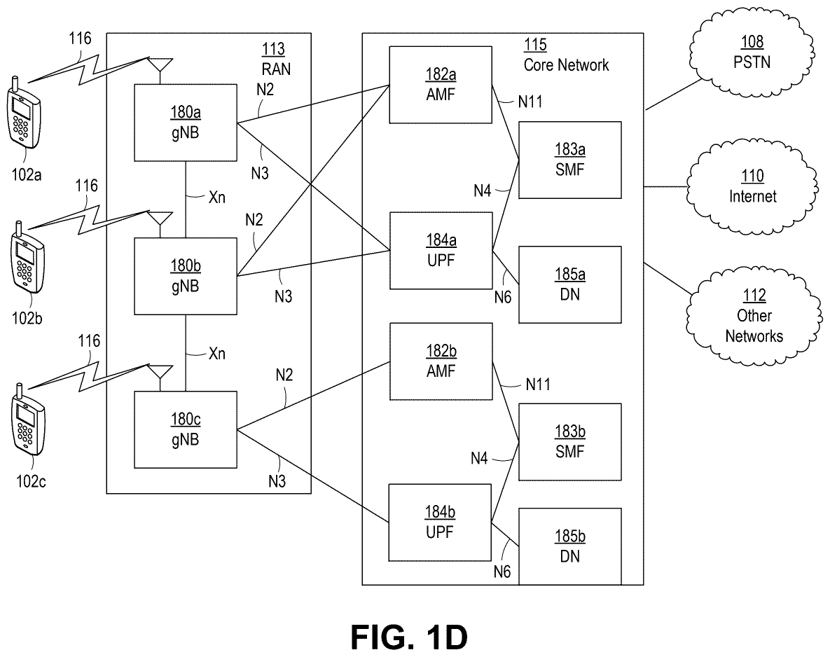

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP (third generation partnership project) access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following terminology is used herein. An antenna may refer to an antenna element, e.g., a physical antenna element. An antenna may also refer to an antenna port, which may correspond to one or more antenna elements, e.g., based on virtualization, beamforming, etc. Hence, antenna may refer to transmitter chain, transceiver unit (TXRU), etc.

An array may correspond to an antenna array of a TRP, a WTRU, a surface, such as a reconfigurable intelligent surface (RIS), a relay, etc. The array geometry may for example correspond to a plane, such as a planar array, a line, such as a linear array, a circle, such as a circular array, or any other geometry. An array may comprise uniformly spaced antennas, e.g., a uniform planar array (UPA) or a uniform linear array (ULA). Antenna spacings may include 0.5\ and 0.81, wherein A is a wavelength, however antenna spacing may also be much smaller, such as in meta surfaces, or similar, or much larger, such as in large spacing arrays. An array may comprise non-uniformly spaced antennas, e.g., uniformly spaced antennas, with a first spacing, in one or more parts of the array, and a second spacing between the parts.

An array may comprise one or more panels, also called sub-arrays. A panel may be a part of an array, e.g., comprise one or more antennas. A panel may comprise a set of adjacent antennas, in some cases even a single antenna. However, in an alternative, a panel may comprise a set of antennas that are not adjacent but instead spread out in the array. A sub-array may correspond to one or more panels. Alternatively, a panel may correspond to one or more sub-arrays. Antennas in a panel may be connected to one or more radio transmitters (transmitter chains), radio receivers (receiver chains), and/or radio transceivers (transmitter and receiver chains). Antennas in a panel may be connected to one radio transmitter, receiver, and/or transceiver, e.g., in the case of partially connected hybrid beamforming architecture. Antennas in a panel may be connected to multiple radio transmitters, receivers, and/or transceivers, e.g., in the case of fully or partially connected hybrid beamforming architecture.

Each antenna may be connected to a transmitter, receiver, and/or transceiver, e.g., in the case of digital beamforming architecture. In this case, a panel may comprise a single antenna. Alternatively, a panel may comprise multiple antennas, even all antennas in the array, and therefore may correspond to multiple transmitters, receivers, and/or transceivers. A panel may comprise uniformly or non-uniformly spaced antennas. The spacing between adjacent panels may be the same as or different than the spacing between antennas within the panel.

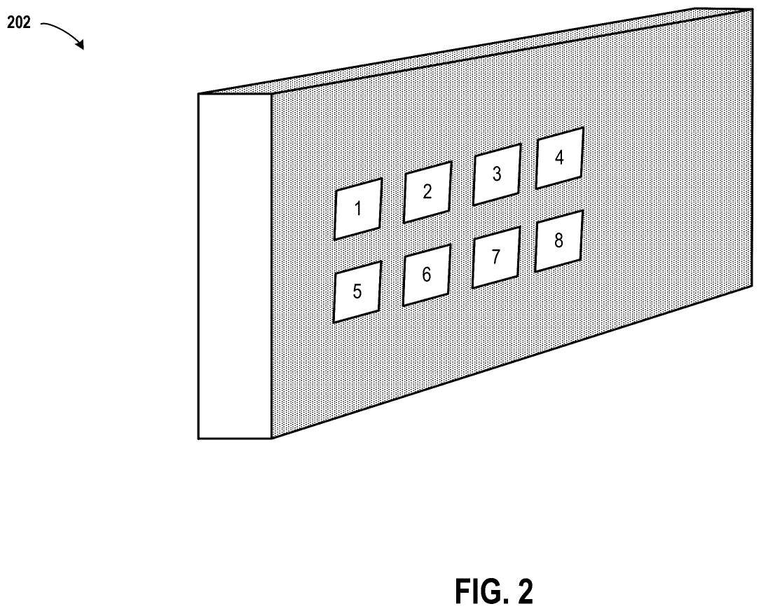

FIG. 2 is an example illustration of an array (202) comprising 8 panels mounted on a planar wall. Different panels may use the same or different antenna spacing. In some arrays, e.g., as illustrated in FIG. 2, adjacent panels may be separated by a larger distance than the antenna spacing within a panel, e.g., by many wavelengths, e.g., tens or hundreds of wavelengths. Such a design may be beneficial since it has a large array aperture while having a limited number of antennas.

The near field of an array may correspond to an area, a space, or a set of locations. The near field may be a space within a distance from the array, wherein the distance may depend on the angle from the array. For example, the near field of an array may be where the planar wave approximation is not sufficiently accurate, wherein the sufficient accuracy may depend on the scenario, application, use case, etc. In one example, sufficient accuracy may correspond to a phase error due to the planar wave approximation that is not greater than π/8.

In some cases, the near field of an array may be where the gain of a beamformer (beamforming gain) drops below a certain level from its maximum. The beamformer may be based on the assumption that the planar wave approximation is valid, in which case the beamformer may give the maximum gain in a certain angle. Such a beamformer and corresponding beam may be called an FF beamformer and FF beam. The term beam is discussed in more detail below. An example of FF beamformer is a column from a discrete Fourier transform (DFT) matrix. The region within which the FF beamforming gain drops below a certain level is sometimes called the focus region. In other words, the term near field may refer to the focus region.

Within the focus region, the array may generate spot beams for transmission and/or reception. Sometimes, transmission or reception of a spot beam is called beamfocusing. A spot beam may have a distance-dependent beamforming gain, or beamfocusing gain. For example, the maximum beamfocusing gain is obtained at a particular angle and distance from the array, sometime called the focus point. Beamfocusing gain no less than X dB (e.g., 3 dB) below the maximum may be obtained within an area or space around the focus point. This area or space is sometimes referred to as the spot beam.

Whether a second array is in the near field of a first array may depend on various properties of the first and second array, such as the aperture, array orientation, relative orientation between the first and second array, distance between the array centers, considered wavelength, etc.

In some cases, a WTRU array may be in the near field of a TRP array, while the TRP is not in the near field of a WTRU array. In other cases, a WTRU array may be in the near field of a TRP array, while the TRP is in the near field of the WTRU array. In some cases, perhaps rarer, a TRP array may be in the near field of a WTRU array while the WTRU array is not in the near field of the TRP array.

A resource as described herein may refer to any appropriate resource. For example, a resource may refer to a channel state information reference signal (CSI-RS) resource. The term channel state information reference signal (CSI-RS) may for example refer to one or more CSI-RS resource(s) or one or more antenna ports of one or more CSI-RS resources, wherein a CSI-RS resource may be a non-zero power CSI-RS resource (NZP-CSI-RS resource). CSI-RS may also more generally refer to a downlink (DL) RS, and/or one or more antenna ports thereof, such as a synchronization signal (SS) and physical broadcast channel (PBCH) block (SS/PBCH block or SSB), physical DL control channel (PDCCH) demodulation RS (DMRS), physical downlink shared channel (PDSCH) DMRS, etc.

In some cases, a set of CSI-RSs corresponds to a set of CSI-RS resources, e.g., a channel measurement resource in a CSI reporting configuration. A CSI-RS may correspond to the antenna ports of one or more CSI-RS resources. For example, the number of CSI-RSs in a set of CSI-RSs may be equal to the number of CSI-RS resources in a corresponding set of CSI-RS resources. A CSI-RS may correspond to all antenna ports of a CSI-RS resource. The different CSI-RSs in a set of CSI-RSs may correspond to antenna ports, e.g., all antenna ports, of different CSI-RS resources.

In another example, the number of CSI-RS in a set of CSI-RS may be greater than the number of CSI-RS resources in a corresponding set of CSI-RS resources. For instance, a first CSI-RS may correspond to a first subset of antenna ports of a CSI-RS resource and a second CSI-RS may correspond to a second subset of antenna ports of the CSI-RS resource. In one case, a set of CSI-RS may correspond to a single CSI-RS resource, wherein different CSI-RSs in the set of CSI-RSs correspond to different, e.g., disjoint, subsets of antenna ports of the CSI-RS resource. In yet another example, the number of CSI-RSs in a set of CSI-RSs may be smaller than the number of CSI-RS resource in a corresponding set of CSI-RS resources. For instance, a CSI-RS may correspond to the antenna ports, e.g., the union of antenna ports, in multiple CSI-RS resources.

A CSI-RS may correspond to a panel. A set of CSI-RSs may correspond to multiple panels, e.g., the multiple panels of a TRP, the multiple panels of multiple TRPs, or the single panels of multiple TRPs.

A beam may correspond to one or more matrices or vectors that may be used to map a signal/channel, e.g., information or reference symbols, to an antenna. An element of the matrix/vector may correspond to an antenna. The matrix/vector may comprise complex numbers, e.g., in polar form with a magnitude and an angle. The complex number magnitude may correspond to an amplitude scaling applied to the signal/channel for the corresponding antenna. The complex number angle may correspond to a phase shift applied to the signal/channel for the corresponding antenna. The mapping operation may for example be performed in one or more digital baseband processing unit(s), e.g., by matrix/vector multiplication between a matrix/vector corresponding to one or more beam(s) and a matrix/vector containing information and/or reference symbols.

A matrix or vector that corresponds to one or more beams may be called a precoder, precoding matrix/vector, codeword, and/or spatial domain (SD) basis. A beam, precoder, or precoding matrix/vector may correspond to a weighted sum, e.g., linear combination, of one or more matrices/vectors.

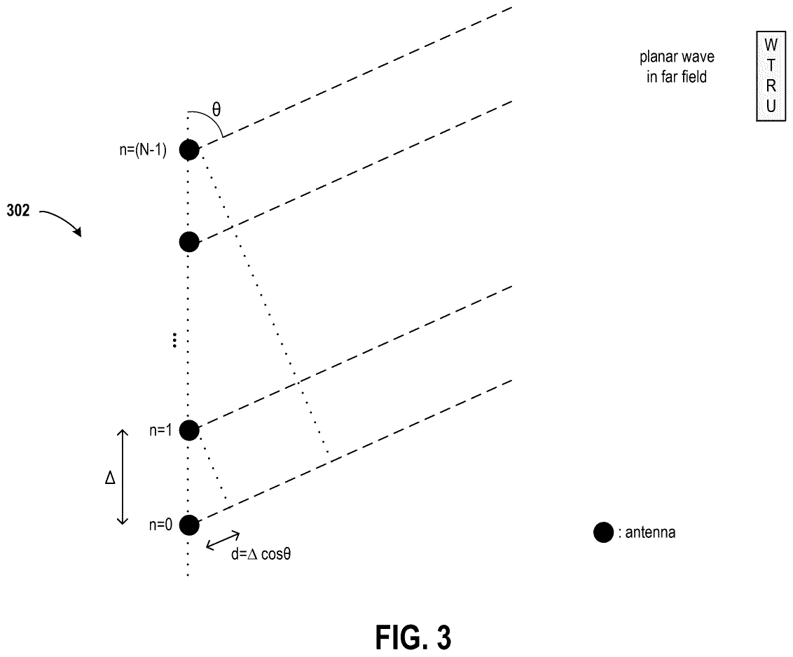

FIG. 3 is a an example illustration of a uniform linear array (302) and a WTRU in the far field of the array. A beam may be represented by the vector wₗ of length N₁, as in Equation 1, where l may correspond to a beam index.

$${p}_{l}^{w}$$

may correspond to an amplitude scaling factor,

$${φ}_{l , n}^{w}$$

may correspond to a phase shift for the n:th antenna, and N₁ is the number of antennas.

$${w}_{l} = {{p}_{l}^{w} [ \begin{matrix}\begin{matrix}\begin{matrix}{e}^{j {φ}_{l , 0}^{w}} \\ {e}^{j {φ}_{l , 1}^{w}}\end{matrix} \\ ⋮\end{matrix} \\ {e}^{j {φ}_{l , ( {N}_{1} - 1 )}^{w}}\end{matrix} ]}^{T} \qquad Equation 1$$

For example,

$${φ}_{l , n}^{w} = n {\overline{φ}}_{l}^{w} ,$$

which Corresponds to linear phase progression from element (antenna) to element (antenna) in the vector. Such a vector may correspond to a proper beam for beamforming to a WTRU in the far field, e.g., if the N₁ antennas correspond to a uniform linear array (ULA), as illustrated in FIG. 3. Note that an array may correspond to a sub-array, e.g., in the context of beams, codebooks, etc. The element-to-element phase shift φ̅ₗ may correspond to the direction of the main lobe of the lₜₕ beam. For instance, the direction θₗ of the beam may be given by Equation 2, where Δ is the antenna spacing and λ is the wavelength.

$$cos {θ}_{l} = \frac{λ}{2 π Δ} {\overline{φ}}_{l}^{w} \qquad Equation 2$$

For a planar array, e.g., a rectangular array, a beam may be described as a Kronecker product between two vectors, as in Equation 3, where the first vector, e.g., wₗ, corresponds to a beam in a first dimension, e.g., horizontal, and the second vector, uₘ, corresponds to a beam in a second dimension, e.g., vertical.

$${V}_{l , m} = {w}_{l} ⊗ {u}_{m} \qquad Equation 3$$

For far field beamforming, uₘ may be similar to wₗ in Equation 1, but with separate parameters, as in Equation 4. The amplitude scaling is denoted

$${p}_{m}^{u} ,$$

the phase shift of the n:th antenna is

$${φ}_{m , n}^{u} ,$$

and N₂ is the number of antennas in the second dimension.

$${u}_{m} = {p}_{m}^{u} [ \begin{matrix}\begin{matrix}\begin{matrix}{e}^{j {φ}_{m , 0}^{u}} \\ {e}^{j {φ}_{m , 1}^{u}}\end{matrix} \\ ⋮\end{matrix} \\ {e}^{j {φ}_{m , ( {N}_{2} - 1 )}^{u}}\end{matrix} ] \qquad Equation 4$$

Similarly, as for the first dimension, the phase shifts in uₘ may be linearly increasing from element to element, e.g.,

$${φ}_{m , n}^{u} = n {\overline{φ}}_{m}^{u} .$$

Note that the antenna spacing Δ may be different or the same in the first and second dimension.

For example, based on Equation 4, V_{l,m} may be a vector of length N₁N₂. In an alternative, V_{l,m} may be a matrix of dimensions N₁×N₂, e.g., V_{l,m}=wₗ^{T}⊗uₘ, or a matrix of dimensions N₂×N₁, e.g., V_{l,m}=wₗ⊗uₘ^{T}.

The angles of interest of an array, e.g., an angular range, may be the angles towards which beamforming may be considered meaningful. For example, the angles in front of the array may be of interest, e.g., angles (θ) between 0 and 180° in FIG. 3. For multi-dimensional beamforming, e.g., from a planar array, there may be angles of interest in the multiple dimensions, for example a first range of angles of interest in the horizontal dimension and a second range of angles of interest in the vertical dimension.

In some cases, a beam may correspond to multiple angles in a dimension, even within the angles of interest for the dimension. For example, for a uniform array with antenna spacing greater than λ/2, there may be multiple lobes of equal gain in multiple angles within 0 and 180° in the dimension.

A codebook may correspond to a set of beams. The beams in the set of beams may have different parameters. For example, a codebook may comprise the set of beams V_{l,m}, with l=0, . . . , L−1 and m=0, . . . , M−1, i.e., the codebook comprises LM beams. In an example, L=O₁N₁ and M=O₂N₂, i.e., the codebook comprises O₁N₁O₂N₂ beams. The parameters O₁ and O₂ may be called oversampling parameters or oversampling factors in the codebook. The indices l and m may be beam indices in a first and second dimension, respectively.

In an example codebook

$${φ}_{l , n}^{w} = \frac{2 π l}{{O}_{1} {N}_{1}} n$$

with n=0, . . . , N₁−1 and

$${φ}_{m , n}^{u} = \frac{2 π m}{{O}_{2} {N}_{2}} n$$

with n=0, . . . , N₂−1. An oversampling parameter, e.g., O₁, reduces the phase difference

$${φ}_{l + 1 , n}^{w} - {φ}_{l , n}^{w}$$

between two adjacent beams, e.g., l+1 and l, in the codebook, e.g.,

$${φ}_{l + 1 , n}^{w} - {φ}_{l , n}^{w} = \frac{2 π}{{O}_{1} {N}_{1}} n .$$

In other words, considering Equation 2, a higher oversampling factor may correspond to a finer directional/angular resolution in the codebook, for a given number of antennas. A higher number of antennas also corresponds to a higher directional/angular resolution.

In some cases, a second codebook, e.g., a type II codebook, may be constructed from a first codebook, e.g., a type I codebook. For example, a precoding vector/matrix for a layer based on the second codebook may correspond to a linear combination of precoding vectors/matrices based on the first codebook.

The term ID may correspond to one or more of identity, identities, index, indices, identifier(s), or similar.

As discussed above, a beam in a codebook may correspond to an angle, e.g., the direction or angle of the main lobe of a corresponding transmission beam, e.g., in the far field of the array. The beam angle may be in relation to the orientation in space of the array. Different beams in a codebook may correspond to different angles.

The beams in a codebook may be ordered according to the beam angles. In the case of multi-dimensional beams, the beams may be separately ordered according to the beam angles in the multiple dimensions. For example, the beams in a codebook may be ordered according to the angle in the horizontal dimension and according to the angle in the vertical dimension. The beam ordering may consider the angles of interest, e.g., the angles of interest in which the beam angles corresponding to a beam occurs once.

If the beams in the codebook are determined based on a Kronecker product between two (component) beams corresponding to two dimensions as in Equation 3, e.g., horizontal and vertical, the order in the first dimension may be based on the angles of the (component) beams corresponding to the first dimension and the order in the second dimension is based on the angles of the (component) beams corresponding to the second dimension.

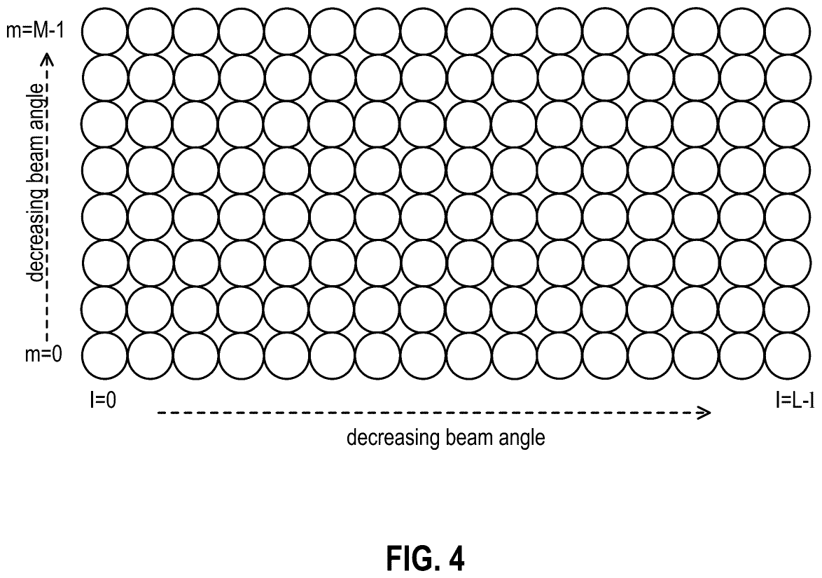

FIG. 4 is an example illustration of angular relationships between beams in a codebook. Consider the codebook discussed above comprising a set of beams V_{l,m}=wₗ⊗uₘ, with l=0, . . . , L−1 and m=0, . . . , M−1. The (component) beams wₗ in a first dimension may be ordered and the (component) beams uₘ may be ordered, according to beam angles. Hence, the beams V_{l,m} may be ordered in two dimensions, as illustrated in FIG. 4.

Two beams with the same index value in a first dimension, but adjacent index values in a second dimension may correspond to the same beam angle in the first dimension, but adjacent beam angles in the second dimension. For example, V_{1,1} may be adjacent to V_{1,2} in the second dimension, in both index and beam angle. Adjacency in beam angle may correspond such that there is no other beam in the codebook with angle between the adjacent beams, e.g., in the first or the second dimension.

Note that if the beams in V_{l,m} would not be ordered according to beam angle, it is possible re-arrange the beam indices in the codebook such that adjacent beam indices correspond to adjacent beam angles. For example, a re-arranged and ordered codebook with beams V_{f(l),g(m)} may be constructed, where f(l) and g(m) are index permutation functions that ensure that beams with adjacent index l or m correspond to beams with adjacent beam angles. For example, w_{f(l)} and w_{f(l+1)} may have adjacent beam angles, and similarly for u_{g(m)}. Note, however, that in many cases, e.g., some legacy 5G NR codebooks, a permutation is not needed, e.g., f(l)=l and g(m)=m.

In a codebook with beam indices, e.g., l=0, . . . , L−1, the angular relationships of the beams with index l=0 and l=L−1 may need to be further considered. In some cases, these indices may correspond to a highest and lowest beam angle supported by the codebook, e.g., among the angles of interest. In other cases, the beam angle may keep decreasing between the beam with index l=L−1 and the beam with index l=0. In other words, there is a wrap around in the codebook, where the beams corresponding to w_{L-1} and w₀ have adjacent beam angles. Similar properties may be applicable to other dimensions, e.g., for uₘ.

As the beam angle is decreased, e.g., by considering higher beam index in the codebook, the lowest angle of interest is reached. Furthermore, some beam index may correspond to the highest beam angle in the codebook within the angles of interest. Hence, the indication of “decreasing beam angle” in FIG. 4 may need further clarification. A first beam index corresponds to the highest beam angle, e.g., within the angles of interest. Increasing the beam index from the first beam index would correspond to a decreasing beam angle. At some point, either the first beam index is reached again, which then corresponds to both the smaller beam angle as well as the highest beam angle, or a beam index that corresponds to the lowest beam angle is reached. In other words, the beam with the next higher beam index may correspond to both a slightly lower beam angle and a significantly higher beam angle, since a beam may correspond to multiple beam angles.

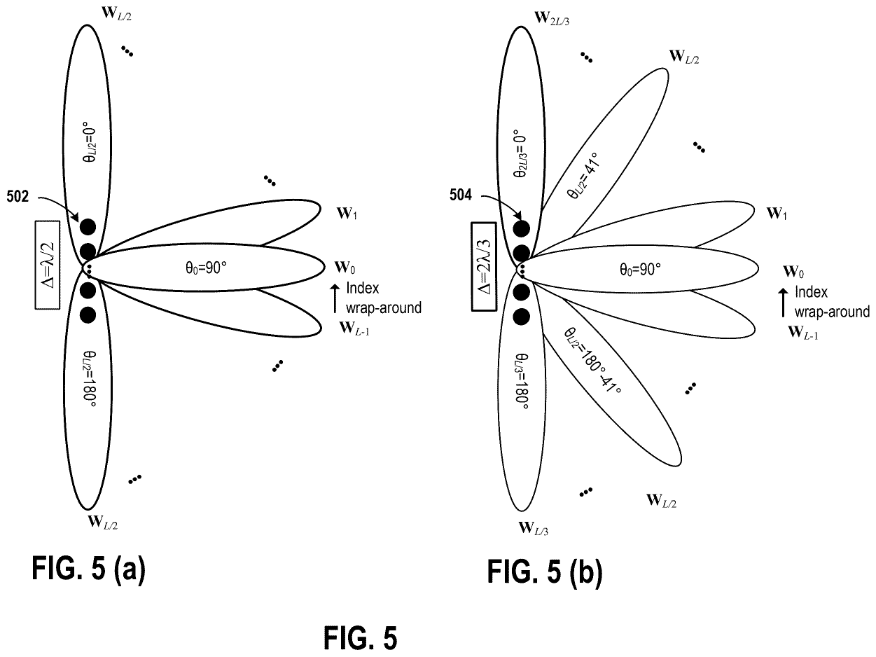

FIG. 5 is an illustration of beam angles from a uniform linear array (ULA). Two examples with a ULA (502, 504) are illustrated in FIG. 5. In FIG. 5(a), the antenna spacing, Δ, is half a wavelength. In FIG. 5(b), the antenna spacing, Δ, is ⅔ of a wavelength. Note that the examples also may be applicable to a dimension of a two dimensional array, e.g., a uniform planar array (UPA). For example, the beam may follow Equation 1 with

$${φ}_{l , n}^{w} = \frac{2 π l}{{O}_{1} {N}_{1}} n$$

with n=0, . . . , N₁−1. FIG. 5(a) illustrates the beam angles (the angle of the oval) of a few beams from a codebook for antenna spacing of half a wavelength (Δ=λ/2). In FIG. 5(b), the antenna spacing is two thirds of a wavelength ((Δ=2λ/3). The angles of interest may be 0°-180° in this example.

In FIG. 5(a), the beam with index L/2 corresponds to the highest beam angle, within the angles of interest. With increasing beam index, the beam angle decreases, with adjacent beam indices corresponding to adjacent beam angles. As discussed above, the beam angle keeps decreasing as the beam index wraps around from L−1 to 0. When the beam index reaches L/2, the minimum beam angle within the angles of interest is reached. Note that the same beam L/2 corresponds to the multiple beam angles 0° and 180°.

The ULA in FIG. 5(b) has greater antenna spacing than in FIG. 5(a). This results in a higher degree of spatial aliasing, i.e., that the multiple beam angles corresponding to a beam in a codebook are closer in angle. For example, as seen in FIG. 5(b), beam with index L/2 now has beam angles 180°-41° and 41°, compared to 180° and 0° in (a). In FIG. 5(b), the highest beam angle is obtained by beam index L/3, while the lowest beam angle is obtained by beam index 2L/3.

In both FIG. 5(a) and FIG. 5(b), and in many other cases considered herein, the beam angle decreases monotonically with increasing beam index, until wrap around, at least within a range of angles, e.g., angles of interest. Also note that the monotonic decrease could be a monotonic increase with a different definition of the angles.

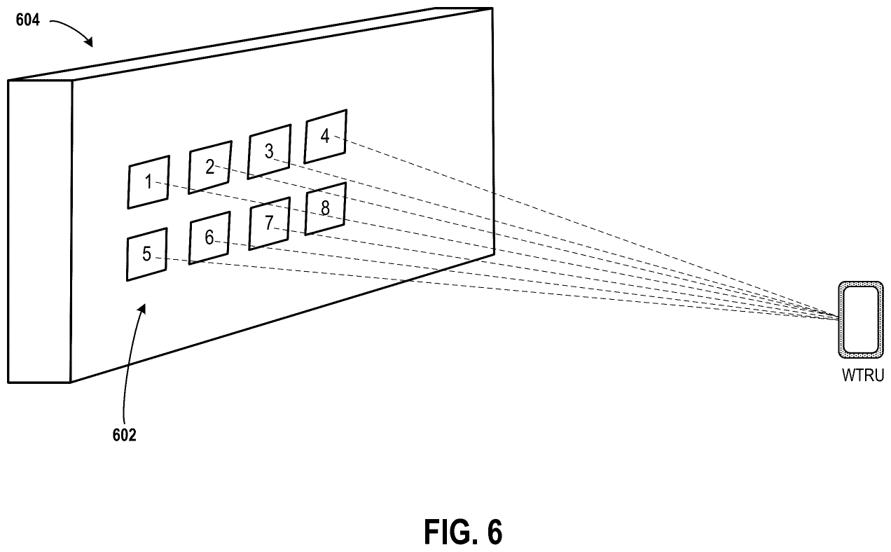

FIG. 6 is an example illustration of angles from panels (602) to a WTRU for a line of sight (LoS) path. Regarding angular properties of near field paths, consider the angles from multiple panels (602) in an array (604) to a WTRU antenna or another object, e.g., a scatterer, in the near field of the array. FIG. 6 illustrates an example of the angles from 8 panels (602) to a WTRU for a LOS scenario. LoS conditions may be more prevalent in the near field than in the far field. The beam angle from a panel to the WTRU can be represented by two angles, e.g., a horizontal (or azimuth) angle and a vertical (or elevation) angle. Even though the beam angles are different for the panels, they may follow a particular structure, where the smallest and largest angles can be found at the edge panels, while the angles from the panels between the edge panels are between the smallest and largest angles. These beam angle relations may be due to the panels have roughly the same orientation in space, for instance by being mounted on the same structure, e.g., a plane such as a wall.

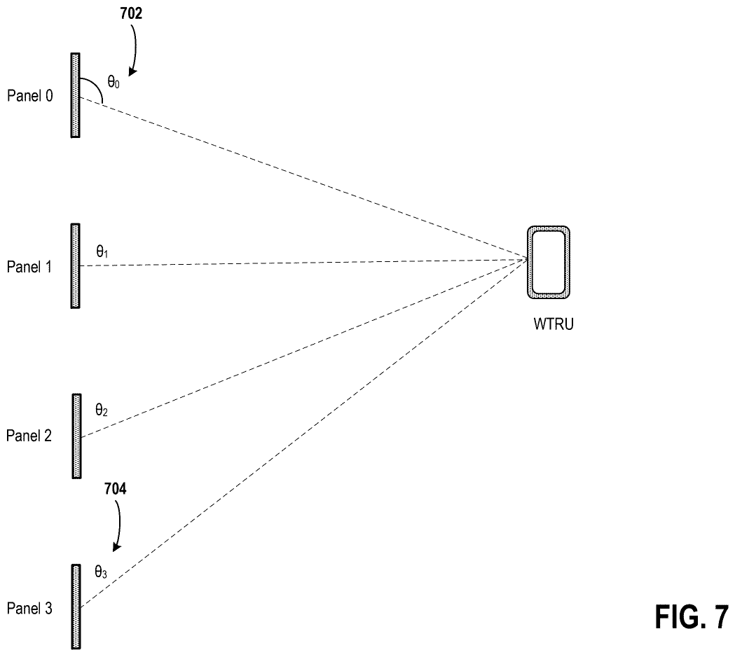

FIG. 7 is an example illustration of angles from panels to a WTRU. To further analyze the relations between the beam angles from the panels, it may be sufficient to consider one of the dimensions. Corresponding relations may typically be applicable in the other dimension as well. As an example, FIG. 7 illustrates the angles from four panels to a WTRU in the near field of the array. Panel 0 and panel 3 are edge panels, and panel 0 has the greatest angle (702) to the WTRU and panel 3 has the smallest angle (704) to the WTRU. For this exemplary deployment, the angles from the panels to WTRU follow an order that holds for any WTRU location on the right side of the array, e.g., for angles of interest between 0° and 180°, as θ₀≥θ₁≥θ₂≥θ₃, where equality may be achieved for instance when the WTRU is in the far field of the array. Similar angular relations may also hold in other examples, e.g., with different numbers of panels. Similar angular relations may simultaneously hold in multiple dimensions for a multi-dimensional array, e.g., a planar array with multiple panels in both the horizontal and vertical dimensions. For example, the relations may hold for each row of panels and each column of panels, e.g., as in FIG. 6.

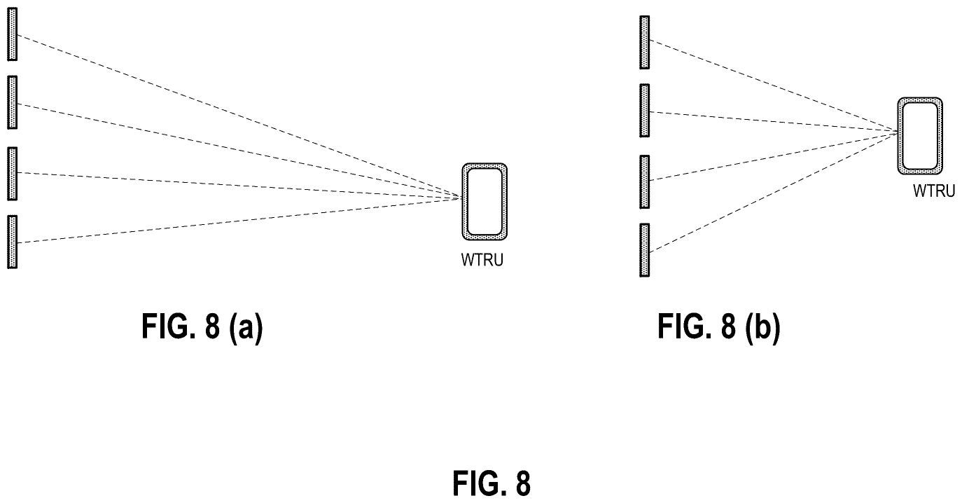

FIG. 8, illustrating FIG. 8(a) and FIG. 8(b), is a depiction of an example of the dependency between the panel-to-panel angle differences and the WTRU distance. The angular difference between two panels, e.g., |θᵢ−θⱼ|, such as between adjacent panels, e.g., |θᵢ−θᵢ₊₁|, may depend on the WTRU location, in relation to the array, in particular the distance between the array and the WTRU. For example, if the WTRU is far away, as illustrated in FIG. 8(a), the angular difference is smaller than if the WTRU is closer to the array, as illustrated in FIG. 8(b). Note that also the angle to the WTRU, e.g., from a reference panel, may influence the angular difference, in addition to the distance.

It is to be understood that independent beam reporting for all panels may be unnecessarily flexible for a near-field path, e.g., the LoS path to a near-field WTRU. The high flexibility comes at the cost of reporting overhead. Thus, it may be sufficient to report the beam for one of the panels with full flexibility, while the beams for the remaining panels may be reported with reduced flexibility and reduced reporting overhead. For example, the angular relationship between adjacent panels discussed above may be used to limit the eligible beams for a panel to only the beams with smaller beam angle. Furthermore, since the typical panel-to-panel angular differences depends on the distance to the WTRU, the corresponding reporting adaptation, e.g., based on the distance, may help to reduce the reporting overhead even further, without sacrificing much of the accuracy.

A WTRU may report its capability. The network may receive the capability reported by the WTRU. A WTRU may report its capability, e.g., in an RRC message, which may be carried in a PUSCH transmitted by the WTRU. The WTRU capability may include one or more of the following aspects.

The WTRU capability may include how frequently, e.g., a minimum periodicity, the WTRU can perform a determination of, or report, parameters for CSI reports, e.g., a determination of beam offset parameters or oversampling factor, etc. The WTRU capability may include maximum and/or minimum beam offset step size, e.g., per dimension or for both dimensions. The WTRU capability may include maximum and/or minimum oversampling factor, e.g., per dimension or for both dimensions. The WTRU capability may include maximum number of CSI-RS. The WTRU capability may include maximum number of antenna port per CSI-RS.

The network may transmit and/or the WTRU may receive one or more configuration(s) and/or reconfiguration(s), e.g., with radio resource control (RRC) signaling, in one or more RRC message(s). The WTRU may be configured with a set of CSI-RSs. The WTRU may receive a configuration of a set of CSI-RSs, e.g., a configured set of one or more CSI-RSs, e.g., in a CSI-RS resource set. The set of CSI-RSs may correspond to a channel measurement resource, e.g., in a CSI reporting configuration.

The set of CSI-RSs may comprise a list of CSI-RSs, e.g., CSI-RS resources. The set of CSI-RSs may comprise a set of CSI-RSs associated with a set of CSI-RS IDs. The WTRU may be configured with an ID range through a starting ID and an end ID (or a size/offset in relation to the starting ID), based on which the set of CSI-RSs is defined, e.g., the CSI-RS with IDs within the range. Alternatively, an ID step size may be configured so that CSI-RS with IDs equal to starting ID+n*(ID step size) are included, where n may be a non-negative integer that may be upper bounded by a configurable maximum number or an end ID.

The WTRU may be configured with single- or multi-port CSI-RS resources. The set of CSI-RSs may correspond to a set of single-port CSI-RS resource(s), a set of dual-port CSI-RS resource(s), or a set of multi-port CSI-RS resource(s), e.g., one or more multi-port CSI-RS resource(s). The set of CSI-RSs may correspond to CSI-RS resource(s) in one or more CSI-RS resource sets, e.g., non-zero-power CSI-RS resource sets. The set of CSI-RSs may correspond to one or more set(s) of antenna ports, e.g., of one or more CSI-RS resource(s). The CSI-RS in the set of CSI-RSs may correspond to the same number of antenna ports or different numbers of antenna ports.

The configured CSI-RS may be based on time-domain behavior. The CSI-RS may be configured to be periodic, e.g., the WTRU may receive the CSI-RS with a configured periodicity and time offset to a time reference. A time reference may, for example, be a slot or frame timing of a serving cell, e.g., the serving cell in which the CSI-RS are configured or received. The CSI-RS may be configured to be semi-persistent. When the CSI-RS is activated, the WTRU may receive the CSI-RS with a configured periodicity and time offset to a time reference. The WTRU may receive a CSI-RS activation and/or deactivation indication for a semi-persistent CSI-RS in a medium access control (MAC) control element (CE) or in a downlink control information (DCI). A MAC CE may be carried in a PDSCH. A DCI may be carried in a PDCCH.

The CSI-RS may be configured to be aperiodic, e.g., the WTRU may receive one or more occasions of an aperiodic CSI-RS after the reception of a DCI that triggers the CSI-RS. The WTRU may receive the CSI-RS a time offset after receiving the PDCCH that carried the DCI that triggered the CSI-RS, for example a configured time offset, or a time offset indicated by the DCI, or a combination thereof.

The WTRU may be configured with one or more CSI-RS antenna groups. For example, the union of the antenna ports of a set of one or more CSI-RS resources may be divided into one or more CSI-RS antenna groups. The resulting antenna groups may be disjoint or overlapping. In one example, the antenna ports of a CSI-RS resource, e.g., a P-port resource, may be divided into antenna groups, e.g., G groups with P/G ports each. In another example, multiple antenna groups may correspond to the antenna ports of multiple CSI-RS resources, e.g., the first antenna group corresponds to the antenna ports of the first CSI-RS resource, etc. In yet another example, the union of antenna ports of multiple CSI-RS comprising P antenna ports may be divided into antenna groups, e.g., G groups with P/G ports each. The antenna ports in an antenna group may correspond to antenna ports of one or more CSI-RS resources, e.g., from the configured set of CSI-RS.

A CSI-RS antenna group may correspond to a panel. A set of CSI-RS antenna groups may correspond to multiple panels. A CSI-RS antenna group (or CSI-RS) may be configured with a panel index, e.g., an explicit panel index or an index that is implicitly associated with a panel. The CSI-RS antenna groups in a set of CSI-RS antenna groups may be configured with separate panel indices.

A CSI-RS may correspond to a CSI-RS antenna group. The set of CSI-RS, e.g., the configured set of CSI-RS or a corresponding received set of CSI-RS, or a subset thereof, may correspond to a set of CSI-RS antenna groups, wherein the groups may comprise the same or different numbers of antennas.

The WTRU may receive a configuration that divides the set of CSI-RS into multiple groups of CSI-RSs. In some cases, the WTRU may be configured to determine groups of CSI-RS for CSI reporting. For instance, the WTRU may be configured with multiple CSI-RS group configurations, and the WTRU may be configured to determine and report one of the configurations.

The WTRU may be configured with information associated with CSI reporting. The WTRU may be configured with CSI reporting, for example periodic, semi-persistent, or aperiodic CSI reporting. The WTRU may be configured with a channel and/or corresponding resource for reporting, e.g., one or more PUCCH resource(s) or one or more resource(s) for PUSCH. The WTRU may be configured with resources for channel measurement for the CSI report, e.g., the set of CSI-RS, or a subset thereof. The WTRU may be configured with resources for interference measurement, e.g., a subset of the set of CSI-RS, or other CSI-RS not in the set of CSI-RS.

The WTRU may be configured to report one or more precoders in a CSI report, e.g., in the form of one or more PMIs. For PMI reporting, the WTRU may be configured with one or more codebooks, as well as corresponding parameters, such as the following, for example. The WTRU may be configured with codebook type, e.g., multi-panel codebook, multi-TRP codebook, etc. The WTRU may be configured with oversampling factor(s) or set(s) of oversampling factors. Oversampling factor(s) or set(s) of oversampling factors may be configured per dimension. A set of oversampling factors may correspond to a set of candidate parameter values from which the WTRU may select one or more values to be used for a CSI report. The WTRU may be configured with codebook subset restriction. The WTRU may be configured with the number of panels, e.g., per dimension.

The WTRU may be configured with beam offset parameter(s), such as one or more of a step size, a range, a max value, a min value, a beam offset set, etc. Set(s) of beam offset parameters may be configured, e.g., a set of step sizes, a set of ranges, a set of beam offset sets, etc. Beam offset parameter(s) or set(s) of beam offset parameters may be configured per dimension. Beam offset parameter(s) or set(s) of beam offset parameters may be configured for one or more panels or CSI-RS. A set of beam offset parameters may correspond to a set of candidate parameter values from which the WTRU may select one or more values to be used for a CSI report.

A configuration of precoder reporting may be applicable to one or more CSI-RS.

A WTRU configured with groups of CSI-RSs may assume or constrain that the same beam(s) or precoder is reported for the CSI-RS in the group of CSI-RS. The WTRU may be configured to report beam(s) or precoder for a single CSI-RS in the group of CSI-RS or jointly for the CSI-RS in the group of CSI-RS, thereby reducing reporting overhead.

The WTRU may be configured with conditions or criteria for selecting parameter(s) for CSI reporting, e.g., a beam offset parameter from a set of beam offset parameters and/or an oversampling factor from a set of oversampling factors. The conditions or criteria may be in the form of one or more thresholds. The one or more thresholds may be in terms of a measurement result or a function thereof. For example, the threshold(s) may be in terms of reference signal received power (RSRP), pathloss, a distance, a fraction of a near-field distance such as Rayleigh distance, effective Rayleigh distance, or similar.

The WTRU may be configured with a periodicity of reporting parameter(s) for CSI reporting. The periodicity may to be greater than or equal to a corresponding WTRU capability.

The WTRU may be configured with one or more sub-configurations for CSI reporting. A sub-configuration may comprise a subset of the CSI-RS, e.g., a subset of the set of CSI-RS. The WTRU may determine and report CSI for one or more of the sub-configurations, e.g., by using methods herein, but applied on the corresponding subset(s) of CSI-RS.

A WTRU may be configured with information associated with CSI-RS Relations. The WTRU may receive a configuration corresponding to a set of relations between CSI-RS in the set of CSI-RS. Configurations may be associated with a reference CSI-RS. One or more of the CSI-RSs may be defined or configured as reference CSI-RS. For example, one or more CSI-RSs may be explicitly configured as reference. A CSI-RS may be implicitly configured as a reference CSI-RS, e.g., through the CSI-RS numbers or through panel ID associated with the CSI-RS, as described below. A CSI-RS, e.g., in the set of CSI-RS, that is not a reference CSI-RS may be denoted a non-reference CSI-RS.

The WTRU may receive a configuration with one or more sets of reference CSI-RS. For example, the sets may comprise different numbers of reference CSI-RSs. In one example, the sets may be overlapping, e.g., such that a CSI-RS is included in multiple sets. For instance, a first set may comprise a first CSI-RS, a second set may comprise the first CSI-RS and a second CSI-RS, etc.

A WTRU may be configured with information related to CSI-RS numbers, The CSI-RS may be configured with different numbers. The set of relations may be based on the CSI-RS numbers. The WTRU may determine the CSI-RS with lowest number and/or highest number to be a reference CSI-RS. The numbers may correspond to configured indices, such as CSI-RS resource indices or CSI-RS resource set indices, or a function thereof. For example, the number of a CSI-RS may correspond to the index of a CSI-RS resource that corresponds to the CSI-RS. In another example, the indices may correspond to ordinal positions in a configured list, e.g., a list of CSI-RS resources or CSI-RS resource sets. For instance, a first CSI-RS resource (or set) in the list may correspond to a lowest index, e.g., 0, etc., until the last CSI-RS resource (or set) in the list, that may correspond to the highest index.

If a CSI-RS corresponds to multiple CSI-RS resources, the number may correspond to the lowest or highest index of the corresponding CSI-RS resources. For example, consider a first CSI-RS that corresponds to CSI-RS resources with indices {5,6,7,8}, a second CSI-RS that corresponds to CSI-RS resources with indices {1,2,9,10}, and a third CSI-RS that corresponds to CSI-RS resources with indices {3,4,11,12}. The CSI-RS number of the first, second, and third CSI-RS may for example be 5, 1, and 3, respectively.

A CSI-RS may be configured with information associated with a panel ID. The CSI-RS numbers may be based on the associated panel IDs.

If multiple CSI-RS correspond to a CSI-RS resource, the CSI-RS number may correspond to a function of the configured CSI-RS resource index and the indices of the antenna ports that correspond to the CSI-RS. For instance, the CSI-RS corresponding to the antenna port with the lowest antenna port index may have the lowest CSI-RS number of the CSI-RS corresponding to the same CSI-RS resource. Consider a first CSI-RS that corresponds antenna ports 0-15 of CSI-RS resource with index 5, a second CSI-RS that corresponds antenna ports 16-31 of the same CSI-RS resource with index 5, a third CSI-RS that corresponds antenna ports 0-15 of CSI-RS resource with index 6, a fourth CSI-RS that corresponds antenna ports 16-31 of the same CSI-RS resource with index 6. Now, the lowest CSI-RS number, e.g., 0, may correspond to the CSI-RS associated with the lowest CSI-RS resource index and the lowest antenna port index, which may be the first CSI-RS in this example. The second lowest CSI-RS number, e.g., 1, may correspond to the CSI-RS associated with the lowest CSI-RS resource index and the second lowest antenna port index, which may be the second CSI-RS in this example, or to the CSI-RS associated with the second lowest CSI-RS resource index and the lowest antenna port index, which may be the third CSI-RS in this example, and to on until all CSI-RS have been given corresponding numbers. In this example, the numbers of the first, second, third, fourth CSI-RS resources may be 0,1,2,3, respectively, based on giving numbers to all CSI-RS of the same CSI-RS resource first, or 0, 2, 1, 3, respectively, based on giving numbers to CSI-RS associated with the lowest antenna port index first.

A WTRU may receive a configuration comprising information associated with one-dimensional relations. A WTRU may be configured such that the CSI-RS with the lowest number may be adjacent to the CSI-RS with second lowest number, for example by an enabling parameter in a CSI reporting configuration or in a CSI resource configuration. The CSI-RS with the second lowest number may be adjacent to both the CSI-RS with lowest number and the CSI-RS with third lowest number, etc. The CSI-RS with highest number may be adjacent to the CSI-RS with second highest number. For the example with four CSI-RS with numbers 0, 1, 2, 3, the CSI-RS relations may be described as 0<->1<->2<->3, where “X<->Y” represents that CSI-RS with number X is adjacent to CSI-RS with number Y, and vice versa. The relations may be described as a relational chain. Note that in this example, CSI-RS with numbers 0 and 3 are adjacent to a single CSI-RS, while CSI-RS with numbers 1 and 2 are adjacent to a two CSI-RS.

If the WTRU is configured with multiple reference CSI-RSs among the set of CSI-RSs, the CSI-RS may be divided into multiple, e.g., two, separate relational chains, each with a single reference CSI-RS, wherein each of the chains may follow various embodiments herein.

A WTRU may receive a configuration comprising information associated with two-dimensional relations. A WTRU may be configured with one or more parameters that further describe the CSI-RS relations. For example, two-dimensional relations may be defined through one or more configured parameter(s), e.g., number of rows and/or number of columns. How a WTRU may determine CSI-RS relations based on the configured parameter(s) is further discussed below.

A WTRU may be configured with a matrix with a number of rows and a number of columns, and in which the matrix elements are configured to be associated with CSI-RS, e.g., by configuring CSI-RS resource indices as elements in the matrix. A CSI-RS may be configured with a first number, e.g., as described above, corresponding to a first dimension, and a second number corresponding to a second dimension.

If the WTRU is configured with multiple reference CSI-RSs among the set of CSI-RSs, the CSI-RS may be divided into two separate relational matrices, each with a single reference CSI-RS, wherein each of the relational matrices may be in accordance with mechanisms described herein.

A WTRU may determine relations between CSI-RSs. The WTRU may determine relations between CSI-RSs, e.g., the set of CSI-RSs, based on the received configuration. Relations between CSI-RSs may corresponds to CSI-RSs that are adjacent. The relation may be reciprocal, for example, if a first CSI-RS is adjacent with a second CSI-RS, the second CSI-RS is also adjacent with the first CSI-RS.

Based on the determined relations, the WTRU may determine a reference CSI-RS. If the WTRU is configured with multiple reference CSI-RSs, the WTRU may determine multiple corresponding subsets of CSI-RS, e.g., of the set of CSI-RS, wherein each subset may comprise a reference CSI-RS. In one example, the CSI-RS with CSI-RS numbers greater than the reference CSI-RS with lowest number, but lower than the reference CSI-RS with the second lowest number, may be assigned to a subset together with the reference CSI-RS with the lowest number. The CSI-RS with CSI-RS numbers greater than the reference CSI-RS with second lowest number, but lower than the reference CSI-RS with the third lowest number, may be assigned to a subset together with the reference CSI-RS with the second lowest number. And so on, until the CSI-RSs have been divided into multiple subsets with a reference CSI-RS each. Various methods herein may, for simplicity, be described for a set of CSI-RS and a single reference CSI-RS, but the methods are equally applicable to a subset of CSI-RS with a single reference CSI-RS. With multiple subsets and multiple reference CSI-RS, beam indices may be reported, e.g., with full flexibility, for the multiple reference CSI-RS, and beam offsets may be reported for the non-reference CSI-RS in the subsets, wherein the beam offset may be in relation to the reference CSI-RS in the same subset as the non-reference CSI-RS. The WTRU may determine relational chains or matrices for each subset. The case that all CSI-RS, e.g., in the set of CSI-RS, are reference CSI-RS may correspond to independent beam reporting for each CSI-RS, which may coincide, as a special case, with a state-of-the-art method.

In some cases, the WTRU may be configured with one or more sub-configurations that may define one or more subsets of CSI-RS. The mechanisms described herein may be applied to the one or more subsets. For example, reference CSI-RS(s) may be determined per subset of CSI-RS, relations may be determined per subset of CSI-RS, etc.

A WTRU may determine CSI-RS numbers. As described above, a WTRU may receive a configuration of CSI-RS resource or resource set indices or the panel IDs/indices that the CSI-RSs are associated with. Based on the indices, the WTRU may determine CSI-RS numbers, e.g., as described above. Note that the CSI-RS numbers may directly correspond to indices of resources or resource sets or the associated panel, in some cases. Other examples are described above.

A WTRU may determine one-dimensional relations. As described above, the WTRU may determine one-dimensional relations between CSI-RS based on the numbers, such that a first CSI-RS with a first number is determined to be adjacent to the CSI-RS with immediately lower number, if any, and to the CSI-RS with immediately higher number. This may result in a chain of adjacency, or relational chain, wherein the CSI-RS with lowest number and CSI-RS with highest number are in the ends of the chain with a single adjacent CSI-RS, while the other CSI-RS have two adjacent CSI-RS.

The WTRU may determine the CSI-RS with lowest or highest number as a CSI-RS reference.

In some cases, a CSI-RS configured as reference CSI-RS may be placed at the beginning/end of the relation chain even if it doesn't have the lowest or highest number, e.g., before the non-reference CSI-RS with lowest number or after the non-reference CSI-RS with highest number. In other cases, the reference CSI-RS may be placed in the relation chain according to the same principle as for the non-reference CSI-RS, e.g., based on the CSI-RS numbers.

A WTRU may determine two-dimensional relations. The WTRU may be configured with a number of rows and/or a number of columns that the WTRU may use to determine the dimensions of a relations matrix. The relations matrix may comprise at least as many elements as CSI-RS. If only the number of rows is configured, the WTRU may determine the number of columns to be equal to the number of CSI-RS divided by the number of rows, with rounding towards infinity, if needed. Similarly, if only the number of columns is configured, the WTRU may determine the number of rows to be equal to the number of CSI-RS divided by the number of columns, with rounding towards infinity, if needed. If both a number of rows and a number of columns is configured, the WTRU may determine the size of the relations matrix accordingly.

The WTRU may assign CSI-RS (or corresponding CSI-RS numbers) to elements in the relations matrix. For example, the WTRU may assign the CSI-RS to elements according to CSI-RS number, in a row-first or a column-first manner. For example, consider a set of eight CSI-RSs with CSI-RS numbers between 0 and 7 and a 2×4 relations matrix P. The relations matrix in Equation 5 may correspond to a row-first assignment and the relations matrix in Equation 6 may correspond to a column-first assignment. The matrices show the CSI-RS numbers of the corresponding CSI-RS.

$$P = [ \begin{matrix}0 & 1 & 2 & 3 \\ 4 & 5 & 6 & 7\end{matrix} ] \qquad Equation 5$$

$$P = [ \begin{matrix}0 & 2 & 4 & 6 \\ 1 & 3 & 5 & 7\end{matrix} ] \qquad Equation 6$$

If the number of elements in the matrix is greater than the number of CSI-RS, the last element(s) in the assignment may be empty without a corresponding CSI-RS. In some cases, the WTRU may receive a configuration of the relations matrix, e.g., with a configurable assignment of CSI-RS to elements. The WTRU may determine an element in the matrix as a reference CSI-RS, e.g., a corner element such as the first or last element in the first row or the first or last element in the last row of the matrix.

In some cases, a CSI-RS configured as reference CSI-RS may be placed at a particular, e.g., predefined position in a relational matrix, e.g., in a corner of the matrix, while the non-reference CSI-RS may be placed according to a method described herein, e.g., based on CSI-RS numbers.

In some cases, a CSI-RS configured as reference CSI-RS may be defined as the CSI-RS which is associated with a specific panel location within the multi-panel array, e.g., a middle panel, a corner panel, etc. The association between non-reference CSI-RS and panel may be determined according to one or more method described in the present disclosure.

Based on a relations matrix, the WTRU may determine which CSI-RS, e.g., which pairs of CSI-RS, that are adjacent. Note that a CSI-RS may be adjacent to multiple, e.g., up to 4, other CSI-RS. For example, a CSI-RS may be adjacent to another CSI-RS that is immediately to the left, right, below, or above the CSI-RS. The number of adjacent CSI-RS may depend on the location of the CSI-RS in the relations matrix. For example, the CSI-RS in the upper left corner of the matrix may have two adjacent CSI-RS, e.g., the CSI-RS to the right and the CSI-RS below.

In the example in Equation 5, CSI-RS 0 is adjacent to CSI-RS 1 (to the right) and CSI-RS 4 (below). CSI-RS 1 is adjacent to CSI-RS 0 (to the left), CSI-RS 2 (to the right), and CSI-RS 5 (below). And so on. In alternative implementations, the CSI-RS adjacency relations may be defined through other representations than a matrix, e.g., a grid, or similar.

A CSI-RS may be configured with a number corresponding to a first dimension and a number corresponding to a second dimension. The WTRU may determine relations between CSI-RS, e.g., adjacency, in the first dimension based on the CSI-RS numbers for the first dimension. Similarly, the WTRU may determine relations between CSI-RS, e.g., adjacency, in the second dimension based on the CSI-RS numbers for the second dimension. Through the configuration of two numbers per CSI-RS, more flexible relations between the CSI-RS may be possible.

Various example physical interpretations may be considered. In an example implementation, different CSI-RSs may correspond to different panels, e.g., TRP panels. Through the configuration and determination of a relations matrix, the WTRU may be implicitly configured with information regarding the structure of the multi-panel array. For example, the relations matrix may correspond to a physical placement of the panels. The CSI-RS corresponding to an element in the matrix may be transmitted from the panel with a corresponding location in the array, e.g., with adjacency to panel from which corresponding adjacent CSI-RS are transmitted. Array implementation, configuration parameters, etc., may be up to the network implementation. The WTRU might not need to assume anything regarding the network implementation. It may be sufficient if the WTRU follows the mechanisms described herein.

The network may transmit and/or the WTRU may receive one or more CSI-RSs, e.g., from the set of CSI-RSs. For instance, the WTRU may receive the set of CSI-RSs, which may comprise a reference CSI-RS and one or more non-reference CSI-RSs. The WTRU may receive one or more occasions of periodic CSI-RS, if any. The WTRU may receive one or more occasions of semi-persistent CSI-RS, if any. The WTRU may receive one or more occasions of triggered aperiodic CSI-RS, if any. If configured, a CSI-RS occasion may comprise CSI-RS repetition. The WTRU may use one or more DL Rx beam(s) for receiving the one or more CSI-RS occasions, whereby the WTRU may determine a DL Rx beam for the CSI-RS. The WTRU may estimate one or more DL channel(s) based on the received CSI-RS. The WTRU may estimate a DL channel for each received CSI-RS.

A WTRU may determine parameters for CSI reporting. Prior to determining a CSI report, the WTRU may determine one or more parameters related to the CSI reporting. Two examples described below are the determination of an oversampling factor and the determination of beam offset parameters. A result of these examples may be that the CSI reporting is adapted to the WTRU propagation situation, such as when the WTRU is deep into the near field or in an outer part of the near field, e.g., near the far field. The parameter adaptation may provide a lower CSI reporting overhead compared to a scheme without adaptation, e.g., with pre-configured parameter(s).

The WTRU may determine one or more parameters based on one or any combination of the following inputs. The WTRU may determine one or more parameters based on an estimated WTRU location, e.g., based on WTRU localization, positioning, and/or sensing methods. The WTRU may determine one or more parameters based on an estimated distance from the TRP array. The WTRU may determine one or more parameters based on an estimated pathloss from the TRP array. The WTRU may determine one or more parameters based on an estimated angle from the TRP array to the WTRU. The WTRU may determine one or more parameters based on an estimated TRP array aperture or effective array aperture from the perspective of the WTRU. The WTRU may determine one or more parameters based on one or more metrics related to near field detection, a fraction of a near-field distance such as Rayleigh distance, effective Rayleigh distance, or similar.

The WTRU may be configured with a set of candidate parameter values for the one or more parameters to be determined. Based on the input(s), the WTRU may select a candidate parameter value from a set of candidate parameter values. The WTRU may compare an input with one or more threshold values and determine the one or more parameters based on the result of the comparison. For example, the WTRU may determine a first parameter value if an input is above or equal to a threshold and a second parameter value if the input is below the threshold. In another example, the WTRU may determine a first parameter value if an input is within a first range of input values, a second parameter value if an input is within a second range of input values, etc.

The one or more determined parameters, e.g., one or more oversampling factors, may be applicable to one or more codebooks, e.g., the configured codebooks or a subset thereof. For instance, the WTRU may apply configured parameter(s) to a subset of the codebooks, e.g., a codebook for a reference CSI-RS, and apply determined parameter(s) to another subset of the codebooks, e.g., a codebook for non-reference CSI-RS. The WTRU may apply the configured parameter(s) to a part of the CSI report, e.g., SD basis or precoder, that is based on the reference CSI-RS, while applying the determined parameter(s) to a part of the CSI report, e.g., SD basis or precoder, that is based on the non-reference CSI-RS. A benefit of applying a configured parameter, e.g., a lower oversampling factor, to the CSI corresponding to the reference CSI-RS than the non-reference CSI-RS may be that the CSI corresponding to the reference CSI-RS may be reported with full flexibility, while the CSI corresponding to the non-reference CSI-RS may be reported with reduced flexibility, which for instance may allow for higher oversampling without the corresponding increased CSI reporting overhead.

The WTRU may determine one or more parameters applicable to a subset of the panels or a subset of the CSI-RS, e.g., a single panel/CSI-RS. Different parameters may be determined for different subsets of panels/CSI-RS. For example, the WTRU may determine a candidate parameter value from a set of candidate parameter values that is applicable to beam determination for a panel/CSI-RS, wherein different panels/CSI-RS may be configured with the same or different sets of candidate parameter values. Note that, in some cases, the sets of candidate parameter values comprise a single parameter value, which may still correspond to that different parameter values may be used for different panels/CSI-RS. Also note that the determination of one or more parameters for a subset of panels/CSI-RS may also be based on the input. The input may be common for the panels/CSI-RS or separate for subsets of panels/CSI-RS. For example, different panels/CSI-RS may be associated separate distance, pathlosses, angles, etc., which the WTRU may use as input when determining one or more parameters for the subset of panels/CSI-RS.

If the WTRU is not configured with a set of candidate parameter values for the one or more parameters, the WTRU may apply default parameter value(s) for the one or more parameters, wherein the default parameter(s) may be defined in a specification. In one implementation, the WTRU may be configured with default candidate parameter values for the one or more parameters and be configured with one or more other candidate parameters values for the one or more parameters. The WTRU may not need to indicate a gNB if the default candidate parameter values is selected/applied. Or, the WTRU may indicate a gNB if another candidate parameters is selected/applied.

The WTRU may determine and/or report CSI for one or more sub-configurations. The WTRU may determine parameters for CSI reporting per sub-configuration or common (jointly) for the one or more sub-configurations.

The WTRU may determine an oversampling factor. The WTRU may determine one or more oversampling factors from one or more sets of oversampling factors based on one or more inputs, e.g., as described above. The WTRU may determine an oversampling factor from a set of oversampling factors based on an input, wherein the oversampling factor may be applicable to one or more dimensions in a codebook, e.g., both horizontal and vertical dimensions. The WTRU may determine a first oversampling factor for a first dimension and a second oversampling factor for a second dimension.

As described above, the oversampling factor impacts the size of the codebook. The oversampling factor also impacts the resolution of the codebook, e.g., the difference between the angles corresponding to two adjacent beams in the codebook. A higher oversampling factor may correspond to finer codebook resolution. For a WTRU at a short distance from the TRP, the difference in angles to the WTRU from adjacent panels may be larger than for a WTRU further away from the panels, in which case the angles to the WTRU from adjacent panels may be quite similar, as illustrated in FIG. 8. Hence, it may be beneficial to use a smaller oversampling factor when the WTRU is closer and a larger oversampling factor when the WTRU is further away, e.g., so that the panel-to-panel beam offset is in the same order both when the WTRU is close and when the WTRU is further away. Furthermore, different oversampling factors, or sets of oversampling factors, may be used for different CSI-RSs, which may correspond to different panels.

Different beam offset parameters may be utilized. A WTRU may use one or more beam offset parameters to determine a set of beam offsets that may be reported. Example beam offset parameters are described below.

A beam offset parameter may comprise a beam offset step size. The step size may correspond to the index difference between the closest beam indices that the WTRU can report, e.g., in a dimension or in both dimensions. For instance, step size 1 may correspond to the WTRU being configured to report a beam offset from a set {0,1,2,3}, {−1, 0, 1, 2}, {0, 1}, or similar. Step size 2 may for example correspond to that the WTRU being configured to report a beam offset from a set {0, 2, 4, 6}, {−3, −1, 1, 3}, {0, 2}, or similar.

A beam offset parameter may comprise a beam offset range: The range may correspond to the minimum and/or maximum beam offset that the WTRU can report, e.g., in a dimension or in both dimensions. For instance, a range of a1-a2 may correspond to the WTRU being configured to report a beam offset from a set {a1, a1+1, . . . , a2−1, a2}, etc. The parameter(s) corresponding to a range may for instance be the minimum offset and/or the maximum offset.

A beam offset parameter may comprise an index among beam offset sets: The WTRU may be configured or pre-configured with a set of beam offset sets. In an example, the set of beam offset sets may be {{0, 1}, {0,2}}. In another example, the set of beam offset sets may be {−1, 0, 1}, {−2, −1, 0, 1, 2}. A beam offset parameter may correspond to an index among the beam offset sets in a set of beam offset sets.

The WTRU may determine one or more beam offset parameters from one or more sets of beam offset parameters based on one or more inputs, e.g., as described above. For example, the WTRU may determine a beam offset parameter from a set of beam offset parameters based on an input, wherein the beam offset parameter(s) may be applicable to one or more dimensions in a codebook, e.g., both horizontal and vertical dimensions. In another example, the WTRU may determine a first beam offset parameter for a first dimension and a second beam offset parameter for a second dimension. In yet another example, the WTRU may determine a first beam offset parameter for a first CSI-RS (e.g., corresponding to a first panel) and a second beam offset parameter for a second CSI-RS (e.g., corresponding to a first panel), wherein the first beam offset parameter may be selected from a first set of beam offset parameters associated with the first CSI-RS and the second beam offset parameter may be selected from a second set of beam offset parameters associated with the second CSI-RS.

For a WTRU at a short distance from the TRP, the difference in angles to the WTRU from adjacent panels may be larger than for a WTRU further away from the panels, in which case the angles to the WTRU from adjacent panels may be quite similar, as illustrated in FIG. 8. Hence, it may be beneficial to use larger beam offsets when the WTRU is closer and smaller beam offsets when the WTRU is further away.

Groups of CSI-RSs may be utilized. The WTRU may be configured with multiple candidate sets of groups of CSI-RS. The WTRU may assume that the same beam(s) is reported for a group of CSI-RS. Hence, the beam(s) for the group of CSI-RS may be reported once, thereby reducing the reporting overhead. The groups of CSI-RS in a set of groups may be disjoint and the union of the groups may correspond to the set of CSI-RS or the set of non-reference CSI-RS. In some cases, a group of CSI-RS may be configured as a reference group of CSI-RS. Hence, the WTRU may determine a set of groups of CSI-RS from the candidate sets. The determination may be based on one or more of the inputs described above, the received CSI-RS, etc.

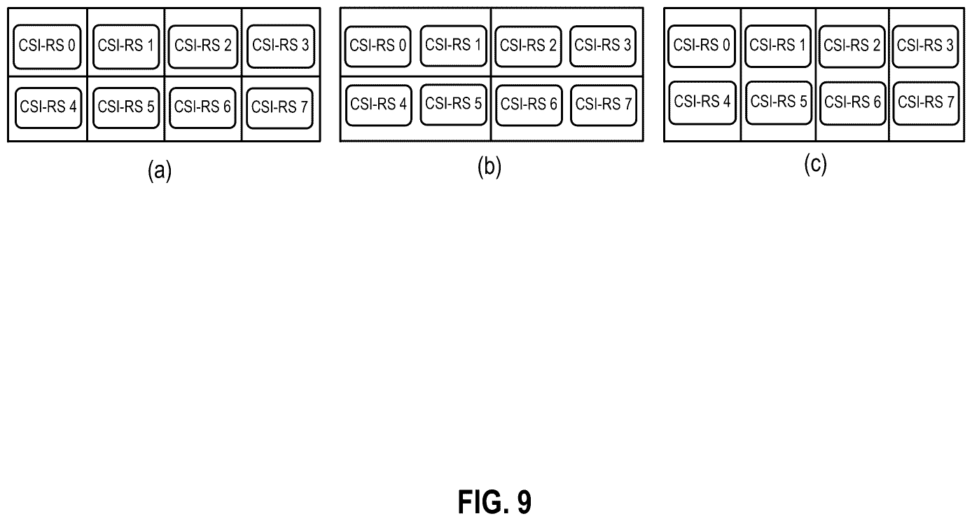

FIG. 9 is an example illustration of three sets (a), (b), and (c), of groups of channel state information reference signals (CSI-RSs). The CSI-RS groups may be based on CSI-RS relations, e.g., adjacent CSI-RS in a relational chain or matrix. Considering a relational matrix as in Equation 5, FIG. 9 illustrates three exemplary candidate sets of group of CSI-RS. In set (a), there is a single CSI-RS in each group. In sets (b) and (c), there are two CSI-RS in each group. In one example, the WTRU may be configured with a set of groups, e.g., one of the three sets of groups. In another example, the WTRU is configured with multiple sets of groups, e.g., through one or more group size parameter(s) and/or a parameter that indicates the dimension(s) over which the group extends. In another example, the WTRU may select a set from the sets, e.g., as described above.

The WTRU may determine one or more reference CSI-RSs. The WTRU may determine one or more reference CSI-RSs based on received CSI-RS or based on one or more input(s) as described above. The WTRU may be configured with or determine a reference CSI-RS, e.g., an initial or default reference CSI-RS, for instance as described herein. Based on the received CSI-RS or other signals, the WTRU may determine to add one or more reference CSI-RSs, e.g., additional reference CSI-RS, resulting in multiple reference CSI-RSs. An indication of the additional reference CSI-RS, if any, may be reported by the WTRU, e.g., as other parameters for CSI reporting, e.g., in the form of ID(s) of the one or more additional reference CSI-RS.

Based on the received CSI-RS, the WTRU may determine one or more additional reference CSI-RSs based on a configured or determined maximum beam offset. For instance, the WTRU may determine a set of suitable beams for the set of CSI-RS, but the enhanced CSI reporting based on beam offsets and based on a first set of reference CSI-RS, may not properly represent/report the set of suitable beams. The WTRU may determine that by adding one or more reference CSI-RSs, the set of suitable beams may be represented/reported. The WTRU may determine and apply the minimum number of additional reference CSI-RS that would result in a condition being fulfilled, e.g., that a set of suitable beams could be represented, that the same estimated spectral efficiency as for independent beam reporting can be achieved, etc. Note that the WTRU may select which one or more CSI-RS from the set of CSI-RS to add as a reference CSI-RS, since the benefit of adding a CSI-RS may be quite different between different CSI-RSs, e.g., due to the associations between CSI-RS and panels, the geometry in current scenario, etc.

In another example, in which the WTRU may be configured with multiple sets of reference CSI-RS, the WTRU may determine a set of reference CSI-RSs. The different sets of reference CSI-RSs may vary in sizes, meaning they can contain different numbers of reference CSI-RSs. The WTRU may select a set of smallest size that may result in a condition being fulfilled, e.g., as described above. The WTRU may be configured with association between the different sets of reference CSI-RSs and one or more measurements, e.g., CSI-RS based measurements (RSRP, SINR), WTRU distance measurements, etc. In this case, the WTRU may first determine a metric (e.g., RSRP, SINR, distance) and then select the set of reference CSI-RS corresponding to the range within which the determined metric falls. The WTRU may determine the reference CSI-RS(s), e.g., based on additional reference CSI-RS or sets of reference CSI-RS, based on one or a combination of the inputs described above.

The WTRU may determine to use enhanced beam reporting. Beam offset(s) may be reported instead of independent beams for the set of CSI-RSs. The enhanced beam reporting may be suitable in certain conditions, but not in others. Therefore, as a part of determining parameters for a CSI report, the WTRU may determine whether to use enhanced beam reporting for a set of CSI-RS or to report beam independently for the set of CSI-RS. Enhanced beam reporting may be beneficial when a channel is dominated by a Line-of-Sight (LOS) path between the TRP and the WTRU. Enhanced beam reporting may be beneficial when the WTRU is in the near field of the TRP.

The WTRU may determine whether the channel is LoS dominant, e.g., by evaluating if the channel delay spread is below a threshold, or by evaluating if the fraction of the power of the strongest path is above a threshold. If so, the WTRU may use one or more other the methods for enhanced beam reporting described herein. If not, the WTRU may use other methods, e.g., state-of-the-art methods with independent beam reporting.

The WTRU may determine if it is in the near field of the TRP, e.g., based on various measurements on DL reference signals, e.g., based on a determined pathloss based on an RSRP measurement, based on a comparison of RSRPs of multiple RSs, etc. If in the near field, the WTRU may use one or more other methods for enhanced beam reporting described herein. If not, the WTRU may use other methods, e.g., state-of-the-art methods with independent beam reporting.

The WTRU may use other metrics to determine which beam reporting method to use for a CSI report. For example, the WTRU may evaluate a performance difference, e.g., based on a difference in spectral efficiency, channel quality indicator(s), or similar, between different methods, e.g., an enhanced beam reporting and independent beam reporting. Based on the performance difference, the WTRU may determine which CSI reporting method to use. For example, if the performance difference is below a threshold, e.g., a predefined or configurable threshold, the WTRU may determine to use an enhanced beam reporting method described herein.

The WTRU may determine to use one or more other the methods for enhanced beam reporting described herein based on the explicit or implicit signaling from gNB. Such signaling may be transmitted through any of or any combination of RRC, MAC-CE and DCI. For example, if the WTRU receives a signaling indicating enhanced, the WTRU may use one or more other the methods for enhanced beam reporting described herein. If the WTRU receives a signaling indicating legacy, the WTRU may use other methods, e.g., state-of-the-art methods with independent beam reporting. In one example, a first CSI reporting configuration, e.g., associated with a first resource for CSI reporting, is configured with independent beam reporting, and a second CSI reporting configuration, e.g., associated with a second resource for CSI reporting, is configured with enhanced beam reporting. The WTRU may transmit a CSI report on the first resource based on independent beam reporting, while transmitting a CSI report based on enhanced beam reporting on the second resource. In another example, a first trigger state for aperiodic CSI reporting is configured with independent beam reporting while a second trigger state is configured with enhanced beam reporting. Upon triggering of the first trigger state, e.g., by a DCI, the WTRU may transmit a CSI report based on independent beam reporting, and upon triggering of the second trigger state, e.g., by a DCI, the WTRU may transmit a CSI report based on enhanced beam reporting.

A WTRU may determine a CSI report. The WTRU may determine a CSI report, e.g., based on the received CSI-RS. The determination may also be based on the determined parameters for CSI reporting, e.g., oversampling factor, beam offset parameters, etc. The CSI report may comprise one or more indications of one or more precoders. For example, the CSI report may comprise a multi-panel precoder. The multi-panel precoder may comprise multiple single-panel precoders. A single-panel precoder from the multiple single-panel precoders may correspond to a received CSI-RS. For example, a reference precoder, e.g., single-panel precoder, may correspond to the reference CSI-RS and a non-reference precoder, e.g., single-panel precoder, may correspond to a non-reference CSI-RS. A received CSI-RS and a corresponding precoder may correspond to a panel, e.g., the reference CSI-RS/precoder may correspond to a reference panel and a non-reference CSI-RS/panel may correspond to a non-reference panel.

The WTRU may determine single-panel precoders based on one or more single-panel codebooks. In an example, the same codebook may be used for both reference and non-reference CSI-RS/panels. In another example, the WTRU may determine the reference precoder based on a first codebook and the one or more non-reference precoders based on a second codebook, wherein the second codebook may be of the same type as the first codebook, but with different parameter settings such as oversampling factor.

A multi-panel precoder may comprise multiple beams. For example, a multi-panel precoder comprising multiple single-panel precoders may comprise one or more beams per panel (e.g., per received CSI-RS).

A precoder, e.g., a multi-panel precoder or a single-panel, may comprise multiple layers, which may correspond to multiple columns or rows in a corresponding precoder matrix. Various cases for precoder reporting may include any combination of the following. A precoder may be applicable to a single beam for a single layer. A precoder may be applicable to a single beam for multiple layers, e.g., the same beam for the multiple layers. A precoder may be applicable to multiple beams for multiple layers, with a single beam per layer. A precoder may be applicable to multiple beams for multiple layers, with the same multiple beams for the multiple layers. In some cases, this case may include that even though the same set of multiple beams may be applicable to multiple layers, per-layer amplitude factors for the multiple beams may be included in the report. For example, if a per-layer beam amplitude factor is indicated to be zero, the corresponding beam may be effectively not applicable to the layer. This may be similar to the case in bullet 5. A precoder may be applicable to multiple beams for multiple layers, with different multiple beams for the multiple layers. In some cases, some layers have multiple beams while other layers have a single beam. In some cases, some layers have the same single or multiple beam(s), similar to above, but other layer(s) have different beam(s).

To further limit the reporting overhead and since under NF, a WTRU may be served by a subset of the antenna array (e.g., subset of the panels/CSI-RS), the WTRU may determine the panels/CSI-RS for which it reports selected beams based on one or more of the following. The WTRU may determine the panels/CSI-RS for which it reports selected beams based on configurations from the NW regarding the number of panels/CSI-RS. The WTRU may determine the panels/CSI-RS for which it reports selected beams based on the corresponding angle of the selected beam for the panel/CSI-RS (e.g., if it is larger than a maximum beam offset, do not report beam for it). The WTRU may determine the panels/CSI-RS for which it reports selected beams based on RSRP (e.g., if the difference between RSRP of reference panel/CSI-RS and a non-reference panel/CSI-RS is above a threshold, do not report beam for this non-reference panel/CSI-RS).

The WTRU may determine and/or report CSI for one or more sub-configurations, wherein a sub-configuration may comprise a subset of the CSI-RS. The WTRU may determine and/or report CSI for each subset of CSI-RS that corresponds to a configured and/or DCI-triggered sub-configuration. The WTRU may report CSI for a subset of the sub-configurations, e.g., the sub-configuration that corresponds to the CSI with highest spectral efficiency and/or CQI.

A WTRU may determine beams (e.g., single beam per CSI-RS). The WTRU may determine, e.g., for one or more layer(s), a beam for the received reference CSI-RS (reference beam) and beam(s) for the set of received non-reference CSI-RS (non-reference beam(s)), e.g., from single-panel type I codebook(s). The WTRU may determine and indicate in a CSI report different beams for different layers by applying the methods herein to the different layers.

The WTRU may determine a reference beam, with one or more reference beam indices, such that the reference beam may be selected freely from the codebook, albeit with any codebook subset restriction indicated from the network. Several methods to determine one or more non-reference beams are discussed below.

Regarding a non-reference beam in relation to reference CSI-RS, the WTRU may determine a non-reference beam such that the one or more beam indices of the non-reference beam are based on the reference beam indices. The non-reference beam index in a first dimension may be based on the reference beam index in the first dimension. Similarly, the non-reference beam index in a second dimension may be based on the reference beam index in the second dimension. The non-reference beam index in a dimension, e.g., first and/or second dimension, may be equal to the reference beam index in the dimension plus a beam offset, wherein the WTRU may select the beam offset from a preconfigured, configured or determined set of beam offsets for the dimension. The sum may be subject to a modulo operation based on the number of beams in the dimension, or the maximum beam index. For instance, a non-reference beam index in a dimension may be equal to (reference beam index in the dimension)+ (beam offset for the non-reference beam in the dimension) (modulo maximum beam index in the dimension).

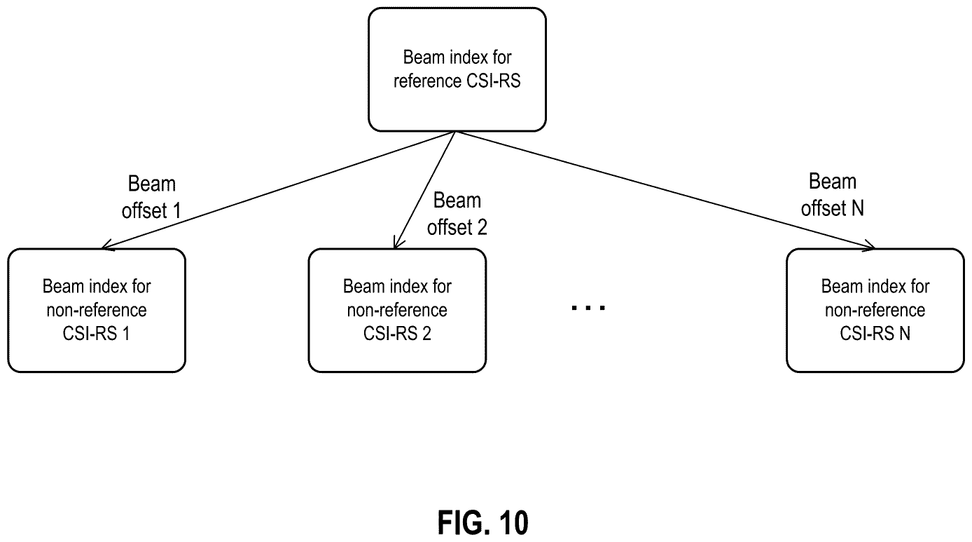

FIG. 10 is an example illustration of relationships between a beam index for the reference channel state information reference signal (CSI-RS) in a dimension and the beam indices of non-reference CSI-RSs in the dimension. The relationship may comprise the beam offsets in relation to the reference beam index. FIG. 10 shows an exemplary illustration of the relationship between the beam index of the reference CSI-RS and the beam indices of N non-reference CSI-RS in a dimension, wherein the beam index for a non-reference CSI-RS is based on the reference beam index and the beam offset corresponding to the non-reference CSI-RS.

The CSI report for the layer may comprise one or more beam indices for a reference beam and one or more beam offsets for each of the one or more non-reference beams. The beam indices for the non-reference CSI-RS might not be included in the CSI report. Since fewer bits are required for a beam offset than for a beam index, the CSI report overhead can be reduced.

An additional advantage of reporting non-reference beams in relation the reference CSI-RS is that relational information might not be needed. The adjacency of non-reference CSI-RS might not need to be defined, configured, or determined.

A non-reference beam in relation to a primary CSI-RS with one-dimensional relations is discussed below. For a non-reference CSI-RS, the WTRU may determine the primary CSI-RS to be the adjacent CSI-RS that is closer to the reference CSI-RS in the relational chain. For example, if the reference CSI-RS is in the beginning of the chain, e.g., due to having the lowest CSI-RS number, the primary CSI-RS of a non-reference CSI-RS may be the adjacent CSI-RS with lower CSI-RS number. Note that a non-reference CSI-RS may have the reference CSI-RS as primary CSI-RS, e.g., if the reference CSI-RS is at one of the ends of the chain. If the reference CSI-RS is not at an end of the chain, two non-reference CSI-RSs may have the reference CSI-RS as primary CSI-RS, e.g., both CSI-RS that are adjacent to the reference CSI-RS.

The WTRU may determine a non-reference beam corresponding to a non-reference CSI-RS such that the one or more beam indices of the non-reference beam are based on the primary beam indices, wherein the primary beam indices may be the beam indices of the beam corresponding to the primary CSI-RS. The non-reference beam index in a first dimension may be based on the primary beam index in the first dimension. Similarly, the non-reference beam index in a second dimension may be based on the primary beam index in the second dimension. The non-reference beam index in a dimension, e.g., first and/or second dimension, may be equal to the primary beam index in the dimension plus a beam offset, wherein the WTRU may select the beam offset from a preconfigured, configured or determined set of beam offsets for the dimension. The sum may be subject to a modulo operation based on the number of beams in the dimension, or the maximum beam index. For instance, a non-reference beam index in a dimension may be equal to (primary beam index in the dimension)+(beam offset for the non-reference beam in the dimension) (modulo maximum beam index in the dimension).

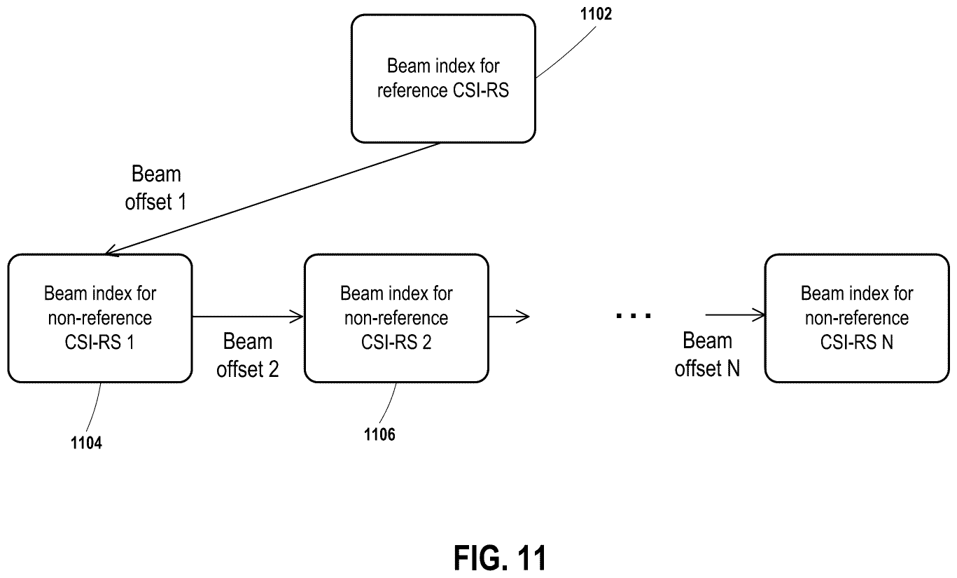

FIG. 11 depicts an example illustration of relationships between the beam indices for the received CSI-RS in a dimension based on a one-dimensional relational chain, wherein the reference CSI-RS is in one end of the chain. In this example illustration, the reference CSI-RS is the primary CSI-RS of non-reference CSI-RS 1, non-reference CSI-RS 1 is the primary CSI-RS of non-reference CSI-RS 2, etc. As depicted, beam index 1102 is associated with the reference CSI-RS, beam index 1104 is associated with non-reference CSI-RS 1, beam index 1106 is associated with non-reference CSI-RS 2, etc.

The CSI report for the layer may comprise one or more beam indices for a reference beam and one or more beam offsets for each of the one or more non-reference beams. The beam indices for the non-reference CSI-RS might not be included in the CSI report. Since fewer bits are typically required for a beam offset than for a beam index, the CSI report overhead can be reduced. An advantage compared to the non-reference beam index reporting in relation to the reference beam, as described above, may be that the fewer bits may be required to represent the beam offsets, e.g., if the beam angles change gradually, e.g., with small steps, from CSI-RS to adjacent CSI-RS in the relational chain.

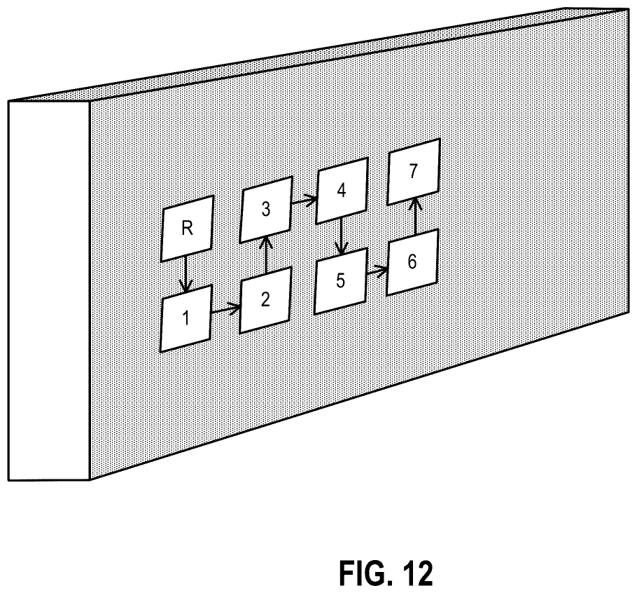

FIG. 12 is an example illustration of a mapping between CSI-RS and panels, wherein R denotes the panel from which the reference CSI-RS is transmitted, and a number n=1, . . . , 7 indicates the panel from which non-reference CSI-RS n is transmitted. The arrows point to a non-reference CSI-RS from the corresponding primary CSI-RS. Depending on the mapping between CSI-RS and physical panels of a TRP, the beam offset set may include both positive and negative beam offsets in one dimension, but only non-negative beam offsets in the other dimension. An example is illustrated in FIG. 12, wherein R denotes the panel from which the reference CSI-RS is transmitted, and a number n=1, . . . , 7 indicates the panel from which non-reference CSI-RS n is transmitted. The lines between the panels illustrate the relational chain between the corresponding CSI-RS, wherein the reference CSI-RS is at one end of the chain.

For the horizontal dimension, the horizontal beam angle may be approximately unchanged between some adjacent CSI-RS, e.g., between the reference CSI-RS and non-reference CSI-RS 1, between non-reference CSI-RS 2 and 3, etc. For the other relations, e.g., between CSI-RS 1 and 2, the horizontal beam angle may change monotonically, e.g., increases. Hence, the beam offset set in the horizontal dimension may be non-negative, e.g., {0, 1}.

On the other hand, for the vertical dimension, the beam angle may either increase or decrease between adjacent CSI-RS in the relational chain. For example, the angle may increase between the reference CSI-RS and the non-reference CSI-RS 1 while the angle may decrease between the non-reference CSI-RS 2 and the non-reference CSI-RS 3. Hence, the beam offset set in the vertical dimension may comprise both positive and negative beam offsets, e.g., {−1, 0, 1}.

Non-reference beams in relation to a primary and a secondary CSI-RSs with two-dimensional relations are discussed below. Regarding a first dimension, for a non-reference CSI-RS, the WTRU may determine a primary CSI-RS to be the adjacent CSI-RS that is closer in a first dimension, e.g., in a relational matrix, to the reference CSI-RS. For example, if the reference CSI-RS is in the first (upper) row and first (leftmost) column of the matrix, the adjacent CSI-RS to the left of the non-reference CSI-RS, but in the same row, may be the primary CSI-RS to the non-reference CSI-RS.

Regarding a second dimension, similarly, for a non-reference CSI-RS, the WTRU may determine a secondary CSI-RS to be the adjacent CSI-RS that is closer in a second dimension, e.g., in a relational matrix, to the reference CSI-RS. For example, if the reference CSI-RS is in the first (upper) row and first (leftmost) column of the matrix, the adjacent CSI-RS above the non-reference CSI-RS, but in the same column, may be the secondary CSI-RS to the non-reference CSI-RS.

Regarding a first dimension, there may be non-reference CSI-RS without an adjacent CSI-RS that is closer in the first dimension to the reference CSI-RS, for example if the non-reference CSI-RS is in the same column as the reference CSI-RS. In this case, the non-reference CSI-RS may be without primary CSI-RS, e.g., the non-reference beam in the first dimension may be equal to the beam of the secondary RS in the first dimension, e.g., without a beam offset. Alternatively, the non-reference beam may be based on a one-dimensional relation as described above but based on the secondary CSI-RS.

In another implementation for this case, the secondary CSI-RS may serve also as a primary CSI-RS for this non-reference CSI-RS. In yet another implementation for this case, the reference CSI-RS may serve as a primary CSI-RS for this non-reference CSI-RS.

Regarding a second dimension, similarly, there may be non-reference CSI-RS without an adjacent CSI-RS that is closer in the second dimension to the reference CSI-RS, for example if the non-reference CSI-RS is in the same row as the reference CSI-RS. In this case, the non-reference CSI-RS may be without secondary CSI-RS, e.g., the non-reference beam in the second dimension may be equal to the beam of the primary RS in the second dimension, e.g., without a beam offset. Alternatively, the non-reference beam may be based on a one-dimensional relation as described above but based on the primary CSI-RS.

In another implementation for this case, the primary CSI-RS may serve also as a secondary CSI-RS for this non-reference CSI-RS. In yet another implementation for this case, the reference CSI-RS may serve as a secondary CSI-RS for this non-reference CSI-RS.

Regarding a first dimension, the WTRU may determine a non-reference beam corresponding to a non-reference CSI-RS such that the first-dimension beam index of the non-reference beam is based on the primary beam index in the first dimension, wherein the primary beam indices may be the beam indices of the beam corresponding to the primary CSI-RS. The non-reference beam index in the first dimension may be equal to the primary beam index in the first dimension plus a first-dimension beam offset, wherein the WTRU may select the beam offset from a preconfigured, configured or determined set of beam offsets for the first dimension. The sum may be subject to a modulo operation based on the number of beams in the first dimension, or the maximum beam index. For instance, a non-reference beam index in the dimension may be equal to (primary beam index in the dimension)+ (beam offset for the non-reference beam in the dimension) (modulo maximum beam index in the dimension).

Regarding a second dimension, similarly, the WTRU may determine a non-reference beam corresponding to a non-reference CSI-RS such that the second-dimension beam index of the non-reference beam is based on the secondary beam index in the second dimension, wherein the secondary beam indices may be the beam indices of the beam corresponding to the secondary CSI-RS. The non-reference beam index in the secondary dimension may be equal to the secondary beam index in the first dimension plus a second-dimension beam offset, wherein the WTRU may select the beam offset from a preconfigured, configured or determined set of beam offsets for the second dimension. The sum may be subject to a modulo operation based on the number of beams in the second dimension, or the maximum beam index. For instance, a non-reference beam index in the dimension may be equal to (secondary beam index in the dimension)+ (beam offset for the non-reference beam in the dimension) (modulo maximum beam index in the dimension).

Consider an example based on a relational matrix as in Equation 5, i.e.,

$$P = [ \begin{matrix}0 & 1 & 2 & 3 \\ 4 & 5 & 6 & 7\end{matrix} ] ,$$

wherein CSI-RS 0 may be the reference CSI-RS (denoted as R in some figures).

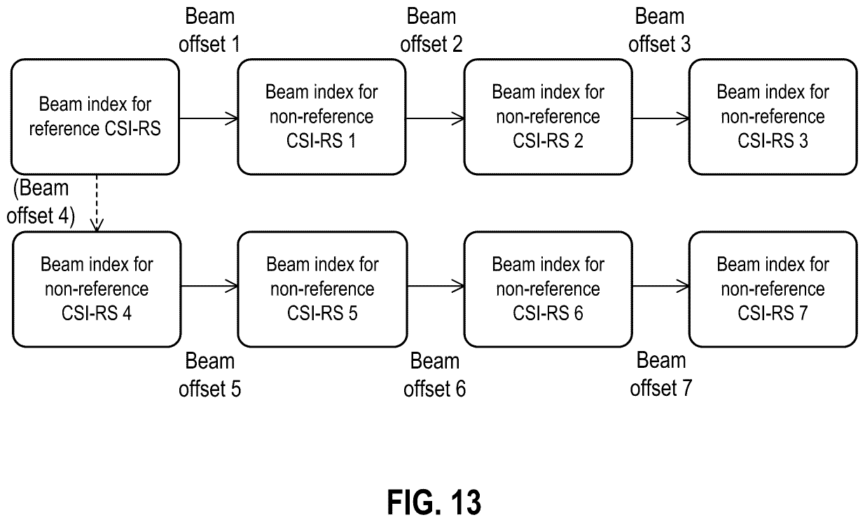

FIG. 13 is an example illustration of relations and beam offsets in a first dimension. An example of the CSI-RS relations in a first dimension, e.g., the horizontal dimension, is illustrated in FIG. 13. The solid arrows point from the primary CSI-RS to the corresponding non-reference CSI-RS. For CSI-RS 4, there is no CSI-RS to the left in the relational matrix. Therefore, various solutions to determine the beam index in the first dimension of CSI-RS 4, as described above, e.g., directly using the beam index of the reference CSI-RS also for CSI-RS 4, or with a beam offset (beam offset 4) from the reference CSI-RS, etc. The CSI reporting of the beams in the first dimension for the 8 CSI-RS may comprise the beam index for the reference CSI-RS and the six (or seven in some solutions) beam offsets.

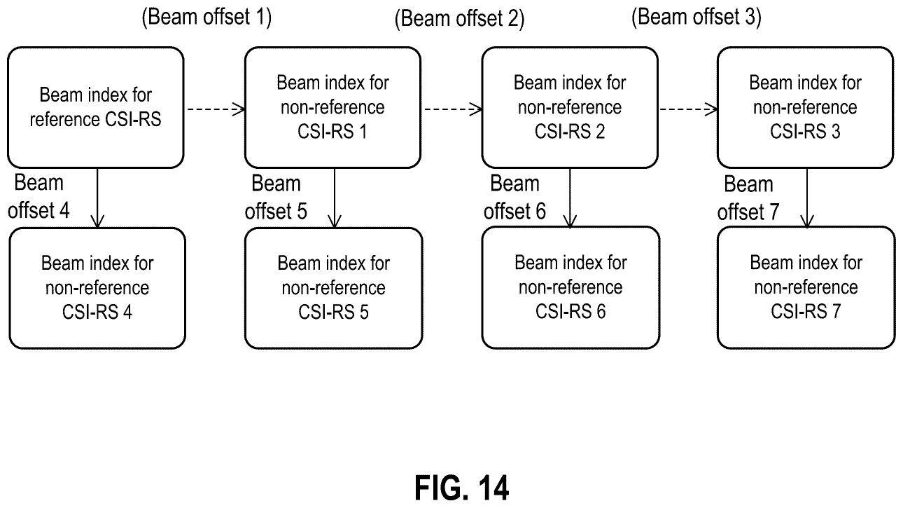

FIG. 14 is an example illustration of relations and beam offsets in a second dimension. The illustration of the example with the CSI-RS relations in a second dimension, e.g., the vertical dimension, is shown in FIG. 14. The solid arrows point from the secondary CSI-RS to the corresponding non-reference CSI-RS. For CSI-RS 1, 2, and 3, there are no CSI-RS above in the relational matrix. Therefore, as for the first dimension, various solutions to determine the beam index in the second dimension of CSI-RS 1, 2, and 3 may be considered, as described above. The dashed line corresponds to one solution in which the beam index in the second dimension may be determined from the beam index of the primary CSI-RS and a beam offset. In other solutions, the same beam index as for the reference CSI-RS is used, and no additional beam offsets are needed. The CSI reporting of the beams in the second dimension for the 8 CSI-RS may comprise the beam index for the reference CSI-RS and the four (or seven in some solutions) beam offsets.

Now, considering the beam reporting for the 8 CSI-RS in both dimensions, the state-of-the-art report would include 8 beam indices in each dimension, i.e., 16 beam indices. In the example illustrated herein, however, the beam indices in both dimensions would only be reported for the reference CSI-RS. Besides that, only 6+4=10 beam offsets (or 7+7=14 beam offsets in an alternative) would need to be reported, also noting that a beam offset can be reported with fewer bits than a beam index.

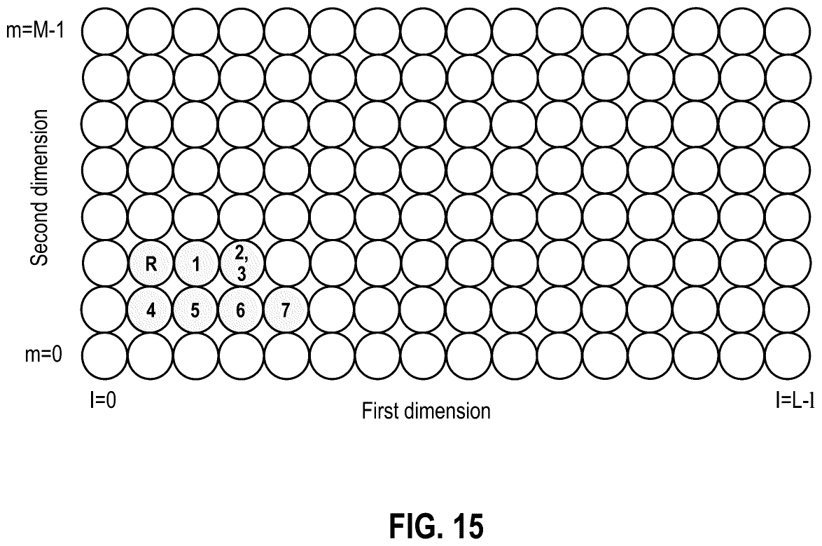

FIG. 15 is an example illustration of beam indices for 8 CSI-RSs, e.g., in a codebook. Example beam indices for the CSI-RS are illustrated in FIG. 15. The beam indices for the reference resource are (1, 2), where the first and second numbers may denote the beam indices in the first and second dimensions, respectively. The beam offset set in the first dimension may be {0, 1} and in the second dimension {0, −1}. For the first dimension, beam offsets 1, 2, 3, 5, 6, 7 may be 1, 1, 0, 1, 1, 1. Hence, since beam offset 3 is 0, the beam index in the first dimension for CSI-RS 3 is the same as for CSI-RS 2. For the second dimension, the beam offsets 4, 5, 6, 7 may be −1, −1, −1, −1.

Comparing the reporting overhead in the example, the full beam index may comprise log 2(M)+log 2(L) bits, e.g., log 2(8)+log 2(16)=7 bits for M=8 and L=16. On the other hand, a beam offset requires only a bit per dimension. Hence, beam reporting using the full beam index for all 8 CSI-RS would require 8*7=56 bits. On the other hand, in accordance with the enhancement presented herein, only 7+6+4=17 bits may be needed, wherein the 7 bits are used for the reference CSI-RS beam index, the 6 and 4 bits are used for the beam offsets in the first and second dimensions, respectively.

A reduced subset of non-reference beams with two-dimensional relations is achievable. Regarding first and second subset of non-reference CSI-RS, the WTRU may determine beams for a first subset of non-reference CSI-RS. The WTRU may determine beams for a second subset of non-reference CSI-RS based on the beams for the first subset. Beams, or beam offsets therefore might not need to be reported, further reducing the CSI reporting overhead. The first and second subset may be disjoint. The union of the first and second subset may be the received non-reference CSI-RS. The first subset of non-reference CSI-RS may correspond to the non-reference CSI-RS that are in the same row or the same column in a relational matrix as the reference CSI-RS.

Regarding beam determination for CSI-RS in the first subset, for a non-reference CSI-RS in the first subset, the WTRU may determine beams based on one of the methods described above. In other words, for a non-reference CSI-RS on the same row in the relational matrix as the reference CSI-RS, the WTRU may determine a primary CSI-RS, e.g., as described above. The WTRU may determine the beam for the non-reference CSI-RS based on the primary CSI-RS. For example, the non-reference beam may be determined such that the first-dimension beam index of the non-reference beam is based on the primary beam index in the first dimension, wherein the primary beam index may be the beam index of the beam corresponding to the primary CSI-RS. The second-dimension beam index of the non-reference beam may be the same as for the primary CSI-RS or the same as for the reference CSI-RS.

Similarly, for a non-reference CSI-RS in the same column in the relational matrix as the reference CSI-RS, the WTRU may determine a secondary CSI-RS, e.g., as described above. The WTRU may determine the beam for the non-reference CSI-RS based on the secondary CSI-RS. For example, the non-reference beam may be determined such that the second-dimension beam index of the non-reference beam is based on the secondary beam index in the second dimension, wherein the secondary beam index may be the beam index of the beam corresponding to the secondary CSI-RS. The first-dimension beam index of the non-reference beam may be the same as for the secondary CSI-RS or the same as for the reference CSI-RS.

Regarding beam determination for CSI-RS in the second subset, for a non-reference CSI-RS in the second subset, the WTRU may determine the beam based on the beam(s) of one or more CSI-RS in the first subset. The beam index in a first dimension may be determined from, e.g., equal to, a first CSI-RS in the first subset, and the beam index in a second dimension may be determined from, e.g., equal to, a second CSI-RS in the first subset. For example, for a non-reference CSI-RS in the second subset, a primary CSI-RS may be determined as the CSI-RS in the first subset that is in the same column in a relational matrix as the non-reference CSI-RS. Furthermore, a secondary CSI-RS may be determined as the CSI-RS in the first subset that is in the same row in the relational matrix as the non-reference CSI-RS. The first-dimension beam index for the non-reference CSI-RS may be equal to the first-dimension beam index for the primary CSI-RS. The second-dimension beam index for the non-reference CSI-RS may be equal to the second-dimension beam index for the secondary CSI-RS.

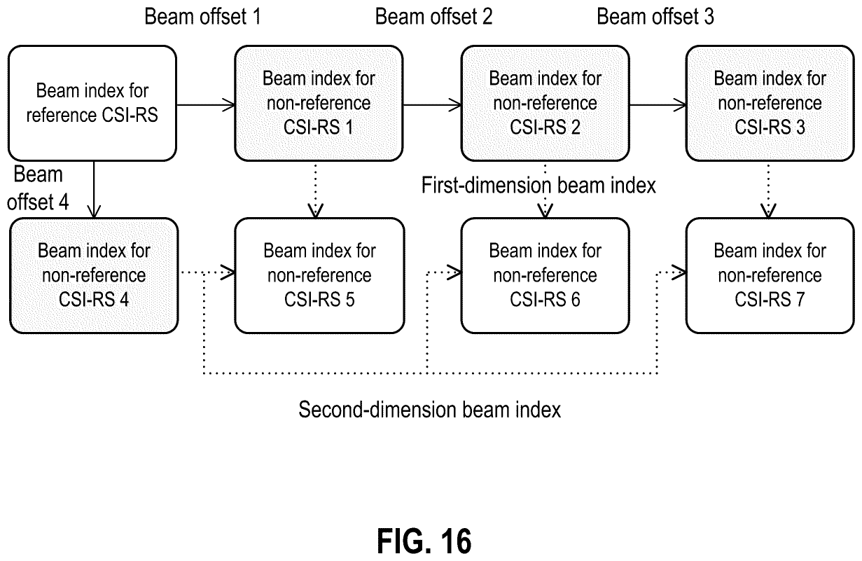

FIG. 16 is an example illustration of beam indices for a reduced subset of CSI-RS. FIG. 16 shows an exemplary illustration of a method described herein, wherein the relational matrix may again be in accordance with Equation 5. The shaded boxes correspond to non-reference CSI-RS in the first subset (non-reference CSI-RS 1-4), since they are in the same row or column as the reference CSI-RS. The remaining non-reference CSI-RS 5-7 comprise the second subset. The WTRU may determine the beam indices of CSI-RS 1-4 in the first subset based on the beam indices and the corresponding beam offset(s), as described in various solutions herein. For the non-reference CSI-RS in the second subset, the beam index in the first dimension may be the same as the first-dimension beam index of the primary CSI-RS, which is the CSI-RS in the first subset in the same column, i.e., right above the non-reference CSI-RS in this example. The beam index in the second dimension may be the same as the second-dimension beam index of the secondary CSI-RS, which is the CSI-RS in the first subset in the same row, i.e., non-reference CSI-RS 4 in this example.

Note that the number of indicated beam offsets is equal to the number of rows plus the number of columns minus one, which is less than in some of the other embodiments presented above, some of which implemented a number of indicated beam offsets in the order of the number of rows times the number of columns.

A similar approach may be formulated as follows. The WTRU may use a first set of (first dimension) beam offsets to determine the first-dimension beam indices for each column in the relational matrix, except the column with the reference CSI-RS, which has the same first-dimension beam index as the reference CSI-RS. Hence, the number of beam offsets in the first set may be equal to the number of columns minus one.

Similarly, the WTRU may use a second set of (second dimension) beam offsets to determine the second-dimension beam indices for each row in the relational matrix, except the row with the reference CSI-RS, which has the same second-dimension beam index as the reference CSI-RS. Hence, the number of beam offsets in the second set may be equal to the number of rows minus one.

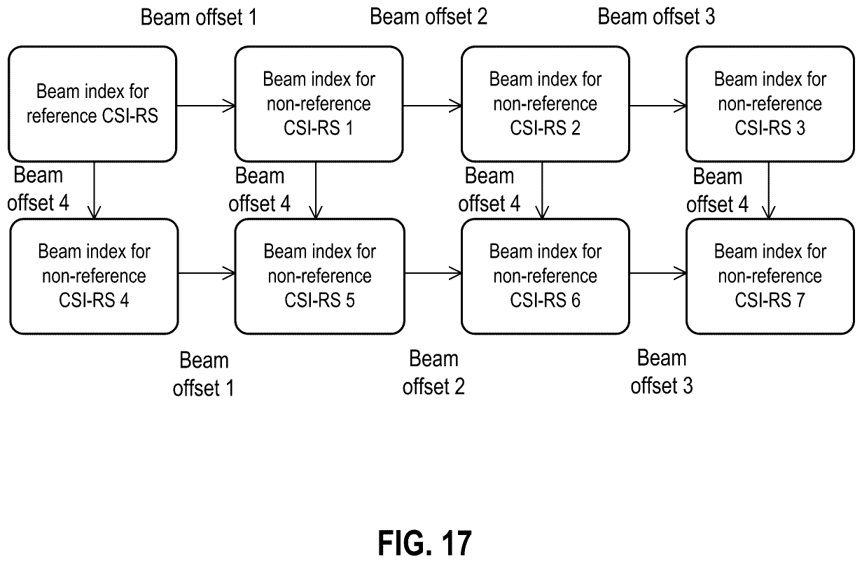

FIG. 17 is an example illustration of reduced beam indices. In FIG. 17 beam offset 1-3 may correspond to the first set of beam offsets. Beam offset 4 may correspond to the second set of beam offsets.

A non-reference beam may be based on higher oversampling than reference beam. In some cases, the WTRU may select the non-reference beams from a codebook with higher oversampling factor than the codebook used for the reference beam. The oversampling factor may be higher in either or both dimensions, in case of two-dimensional beam with two beam indices. Without loss of generality the oversampling factor, beam selection, etc., in a single dimension may be described here. A similar approach may be used for the other dimension.

With the notation defined above, consider the l^{th} beam in a first codebook, e.g.,

$${w}_{l} = {{p}_{l}^{w} [ \begin{matrix}{e}^{j {φ}_{l , 0}^{w}} \\ {e}^{j {φ}_{l , 1}^{w}} \\ ⋮ \\ {e}^{j {φ}_{l , ( {N}_{1} - 1 )}^{w}}\end{matrix} ]}^{T} ,$$

where for instance

$${φ}_{l , n}^{w} = \frac{2 π l}{{O}_{1} {N}_{1}} n$$

with n=0, . . . , N₁−1. The corresponding beam direction θₗ may be formulated as cos

$${θ}_{l} = \frac{λ}{Δ} \frac{l}{{O}_{1} {N}_{1}} .$$

Consider a second codebook with oversampling factor

$${O}_{1}^{′} and {N}_{1}^{′} .$$

In general, the antenna spacing could also be different for the corresponding CSI-RS, i.e., Δ′.

Now, the WTRU may determine a beam l′ in the second codebook that corresponds to the 7th beam in the first codebook. In general, the beam l′ may be determined as the beam in the second codebook that is closest in beam angle to the (th beam in the first codebook. In other words

$${l}^{′} = {arg min}_{q} \vert \frac{q}{{Δ}^{′} {O}_{1}^{′} {N}_{1}^{′}} - \frac{l}{Δ {O}_{1} {N}_{1}} \vert .$$

For example, if

$${Δ}^{′} {O}_{1}^{′} {N}_{1}^{′} = K Δ {O}_{1} {N}_{1} ,$$

where K may be, e.g., an integer, greater than 1,

$$\frac{q}{{Δ}^{′} {O}_{1}^{′} {N}_{1}^{′}} - \frac{l}{Δ {O}_{1} {N}_{1}} = \frac{q}{K Δ {O}_{1} {N}_{1}} - \frac{l}{Δ {O}_{1} {N}_{1}} = ( \frac{q}{K} - l ) \frac{1}{Δ {O}_{1} {N}_{1}} = 0 if q = Kl .$$

For the case that

$${Δ}^{′} = Δ , {N}_{1}^{′} = {N}_{1} , and {O}_{1}^{′} = {KO}_{1} ,$$

the WTRU may determine a beam l′ in the second codebook with higher oversampling factor

$${O}_{1}^{′}$$

that corresponds to beam l^{th} beam in the first codebook as l′=Kl.

In other words, the WTRU may determine a beam index l for the reference CSI-RS from a first codebook and map it to a beam l′=Kl in a second codebook with a K times higher oversampling factor than the first codebook. For the various embodiments herein, in which a beam offset is added to a beam index of the reference CSI-RS, the addition may be based on the reference beam in the codebook with higher oversampling, e.g., with beam index l′, and the beam offset.

The approach with higher oversampling factor for the non-reference CSI-RS than for the reference CSI-RS may be beneficial since the beam index corresponding to the reference CSI-RS/panel may be represented with fewer bits, due to the lower oversampling factor, while allowing beam adjustments for non-reference CSI-RS/panels based on a higher resolution codebook, without the increased beam index reporting overhead, due to the reporting of beam offsets.

Regarding coding of beam offsets, the beam offsets may be correlated, for example if the TRP panels are uniformly spaced. For instance, the WTRU may report the same panel-to-panel beam offset for a dimension for many panels. Hence, to further reduce CSI reporting overhead, the WTRU may encode the beam offsets, e.g., corresponding to a dimension or corresponding to both dimensions, for instance using source coding, such as Huffman coding or run-length encoding.

A WTRU may determine beams (e.g., multiple beams per CSI-RS). The WTRU may determine, e.g., for one or more layer(s), a set of multiple (L) reference beams for the received reference CSI-RS and a set of multiple (L) non-reference beams for the non-reference CSI-RS in the set of received non-reference CSI-RS, e.g., from single-panel type II codebook(s). The WTRU may determine and indicate in a CSI report different sets of beams corresponding to a CSI-RS and for different layers by applying the methods herein to the different layers, e.g., a first set of beams for a first set of one or more layers and a second set of beams for a second set of one or more layers. In various cases, a set of beams corresponding to a CSI-RS is common to all indicated layers in the CSI report.

The WTRU may determine a set of L reference beams, each beam with one or more reference beam indices, such that the reference beams may be selected freely from the codebook, albeit with any codebook subset restriction indicated from the network. The set of reference beams may be ordered, e.g., based on ordering of the reference beams in the CSI report. The set of reference beams may be ordered based on the corresponding beam indices, e.g., a combination of the beam indices in two dimensions for each beam, e.g., ascending or descending. For example, a similar beam ordering as in legacy multi-beam reporting, e.g., in type II codebooks, may be used.

The non-reference beams in the set of non-reference beams for the non-reference CSI-RS may be associated with the beams in the set of reference beams. For example, each non-reference beam in the set of non-reference beams for each of the non-reference CSI-RS may be associated with a beam in the set of reference beams.

For example, a CSI report may comprise multiple parts, e.g., a first part comprising an indication of the set of reference beams. A second part may comprise an indication of the beam offsets for the non-reference beams for the non-reference CSI-RS. The set of beam offsets corresponding to a set of non-reference beams for a non-reference CSI-RS that is indicated in the second part may also be ordered, e.g., based on the order of beam offset encoding in the report.

The WTRU may determine an association between a beam offset and beam in the set of reference beams based on the beam offset ordinal position and the beam ordinal position, wherein the beam offset ordinal position may correspond to the position of the beam offset in the ordered set of non-reference beams for the corresponding non-reference CSI-RS and the beam ordinal position may correspond to the position of the beam in the ordered set of reference beams. For example, the beam offset with the first ordinal position may be associated with the beam with first ordinal position, etc.

For each set of beam offsets for a non-reference CSI-RS, a beam offset may be associated with a reference beam in the set of reference beams. The WTRU may determine a beam for a non-reference CSI-RS by using one or more mechanisms described herein based on the reference beam and the associated beam offsets. To determine multiple non-reference beams for a non-reference CSI-RS, the WTRU may determine a non-reference beam for each beam offset for the non-reference CSI-RS, wherein the non-reference beam for a beam offset is determined based on at least the associated reference beam, and potentially, depending on the method, one or more of the other beam offsets associated with the associated reference beam.

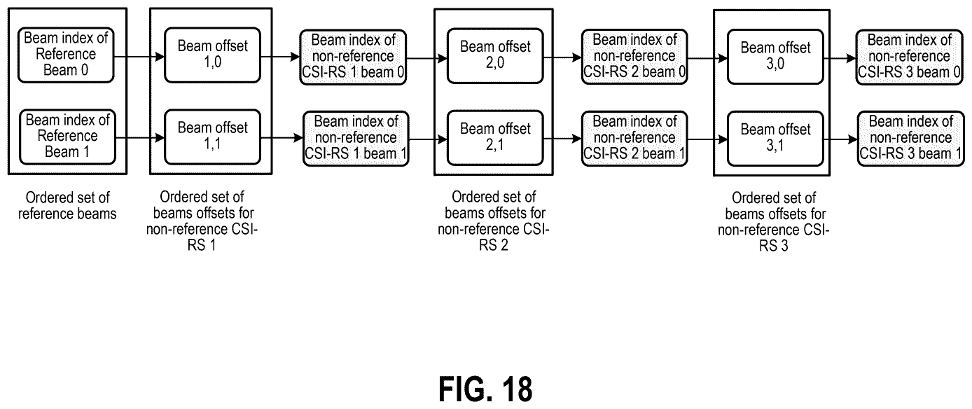

FIG. 18 is an example illustration of a determination of multiple (two) beams per CSI-RS. FIG. 18 illustrates example of determination of a set of two non-reference beams for each of the three non-reference CSI-RS. Beam offset x,y denotes the beam offset for beam y of non-reference CSI-RS x, wherein y corresponds to the ordinal position of the beam offset in the ordered set of beam offsets for CSI-RS x. In this example, the determination of beam index for beam y is based on a relation between the reference CSI-RS, CSI-RS 1, CSI-RS 2, CSI-RS 3, e.g., as described above. Note that only the information in the grey rectangles may be included in a CSI report, e.g., the ordered sets of reference beams and beam offsets.

Beam determination for multiple dimensions, e.g., two, may follow the corresponding mechanisms described herein, but applied to the multi-beam case, as explained here. Any of the mechanisms described herein for the determination of beams for non-reference CSI-RS may be applied to the case with multiple beams, e.g., by applying them per beam and based on the association between beam offsets and reference beams based on the set orders, as described above.

A WTRU may transmit a CSI report. The WTRU may transmit the determined CSI report, e.g., as described above, e.g., in an uplink control information (UCI) or a MAC CE. The CSI report may be carried in one or more PUCCH and/or one or more PUSCH. The CSI report may comprise indication(s) of the determined one or more beam(s), and other parameters discussed herein. The indication(s) may comprise one or more beam indices for the reference precoder and one or more beam offsets for the one or more non-reference precoders, e.g., a beam offset for a first dimension and a beam offset for a second dimension for each non-reference precoder. In case of multiple reference CSI-RS/precoders, the indication(s) may comprise one or more beam indices for the beams corresponding to the multiple reference CSI-RS/precoders.

For example, for multi-beam reporting, the indication(s) may comprise one or more beam indices for each of the beams in an ordered set of beams applicable to the reference precoder. The indication(s) also may comprise one or more ordered sets of beam offsets corresponding to the non-reference beams applicable to each non-reference precoder, wherein a non-reference precoder may be associated with a non-reference CSI-RS.

The CSI report may comprise indication(s) of the determined parameter(s) for CSI reporting, e.g., beam offset parameters, oversampling factor, etc. The parameter(s) may be carried in the same CSI report as the indication(s) of the determined beam(s) or in a different CSI report.

If carried in the same CSI report, the parameter(s) may be carried in a first part of the CSI report, e.g., a part with fixed size. The indication(s) of the determined beams may be carried in the first part or in a second part, wherein the second part may be of variable size, where the WTRU may determine the size of the second part based on the determined parameter(s) indicated in the first part. Alternatively, the parameter(s) may be carried in the second part, while the first part may include an indication of whether the parameter(s) are included in the second part or not. If carried in a different, e.g., previous, CSI report, the WTRU may assume that the most recently reported parameter(s) may be applicable to the present CSI report as well.

The determined parameter(s) for CSI reporting may be reported by the WTRU using a different kind of report or container, e.g., a separate UCI part for this purpose, or a MAC CE. The most recently reported parameter(s) may be applicable to CSI reports that are transmitted a certain time delay after the transmission that carried the reported parameter(s).

In some cases, the WTRU may have reported a capability regarding how frequently it can report parameters for CSI reporting. The WTRU may have received a configuration on the reporting periodicity of parameters for CSI reporting. The WTRU may transmit a report, e.g., CSI report or separate report, with determined parameter(s) for CSI reporting with the configured periodicity, or at least with the configured periodicity. For instance, the report may be carried by a dynamically scheduled PUSCH.

A WTRU may report a single beam per CSI-RS. Directions from the panels to the near-field WTRU (for a path) are correlated. Depending on the locations of the panels in the TRP array, an angular relation between the directions from the panels to the WTRU have a particular structure. For example, the directional angles gradually increase when moving from a panel on one edge of the array to a panel on the opposite edge of the array. Since existing (FF) codebooks generally are structured so that adjacent codewords (beams) correspond to adjacent angles, differential beam reporting (from the codebook) between CSI-RS resources that correspond to adjacent panels can reduce the reporting overhead.

Accordingly, example actions performed by a WTRU may comprise receiving a configuration. The configuration may comprise a set of CSI-RS resources, comprising a first CSI-RS resource (reference panel) configured as reference resource and a set of non-reference CSI-RS resources (panels). The configuration may comprise a codebook (e.g., single-panel type-l) for precoder reporting for each of the CSI-RS resources. The configuration may comprise a two-dimensional (2D)-relation between the CSI-RS resources (panels), e.g., the number of CSI-RS resources in the vertical direction. The configuration may comprise a set of beam offset step sizes for differential beam (SD basis) reporting.

The WTRU may determine a relationship between the CSI-RS resources by ordering them in a 2D grid, based on the configured CSI-RS resources and the configured 2D-relation. The WTRU may receive the set of CSI-RS resources. The WTRU may determine a beam offset step size from the set of beam offset step sizes. The beam offset size may be determined based on the received set of CSI-RS and/or based on a distance measurement. Based on the received CSI-RS resources, the WTRU may determine a first beam (SD basis) for the reference resource from the codebook. Based on the received CSI-RS resources, the WTRU may determine a beam for each of the non-reference CSI-RS resources from the codebook. To determine the vertical beam for a CSI-RS resource, the WTRU may determine a beam with an index equal to the beam determined for the CSI-RS resource below in the 2D grid, plus a beam offset, based on the determined vertical step size. To determine the horizontal beam for a CSI-RS resource, the WTRU may determine a beam with an index equal to the beam determined for the CSI-RS resource to the left in the 2D grid, plus a beam offset, based on the determined horizontal step size.

The WTRU may report the determined beams for the multiple CSI-RS resources. The report may comprise legacy beam indices in the vertical and horizontal directions for the reference resource. The report may comprise an indication of the determined beam offset step size(s). The report may comprise beam offsets in the vertical and horizontal directions for the non-reference CSI-RS resources.

Example actions performed by a network may comprise transmitting the configuration to the WTRU. The network may transmit the set of CSI-RS resources. The network may receive the CSI report, including the beams (SD bases) for the set of transmitted CSI-RS resources. Based on the CSI report, the network may determine a transmission scheme, e.g., a precoder. The network may transmit to the WTRU using the determined transmission scheme, e.g., a PDSCH.

A WTRU may report multi-beam per CSI-RS. The WTRU may determine and report multiple beams/SD bases per CSI-RS and layer. The mechanisms described for a beam per CSI-RS and layer are extended to the multi-beam case by associating beam offsets in an ordered set of beam offsets per non-reference CSI-RS with an ordered set of reference beams, multiple non-reference beams per non-reference CSI-RS can be determined based on beam offsets.

Accordingly, actions performed by a WTRU may comprise receiving a configuration. The configuration may comprise a set of CSI-RS resources, comprising a first CSI-RS resource (reference panel) configured as reference resource and a set of non-reference CSI-RS resources (panels). The configuration may comprise a codebook (e.g., single-panel type-II) for precoder reporting for each of the CSI-RS resources, including a number of beams L. The configuration may comprise a 2D-relation between the CSI-RS resources (panels), e.g., the number of CSI-RS resources in the vertical direction. The configuration may comprise a set of beam offset step sizes for differential beam (SD basis) reporting.

The WTRU may determine a relationship between the CSI-RS resources by ordering them in a 2D grid, based on the configured CSI-RS resources and the configured 2D-relation. The WTRU may receive the set of CSI-RS resources. The WTRU may determine a beam offset step size from the set of beam offset step sizes. The WTRU may determine the beam offset, based on the received set of CSI-RS and/or based on a distance measurement.

Based on the received CSI-RS resources, the WTRU may determine a first ordered set of L (reference) beams (SD basis) for the reference resource from the codebook. Based on the received CSI-RS resources, the WTRU may determine an ordered set of beam offsets for each of the non-reference CSI-RS and for the horizontal and vertical dimensions. Based on the received CSI-RS resources, the WTRU may determine an association between each beam offset with a beam in the set of reference beams based on the ordinal positions in the ordered sets. Based on the received CSI-RS resources, the WTRU may determine an ordered set of L beams for each of the non-reference CSI-RS resources from the codebook.

To determine a vertical beam for a CSI-RS resource, the WTRU may determine a beam with an index equal to the associated beam determined for the CSI-RS resource below in the 2D grid, plus an associated beam offset, based on the determined vertical step size. To determine the horizontal beam for a CSI-RS resource, the WTRU may determine a beam with an index equal to the associated beam determined for the CSI-RS resource to the left in the 2D grid, plus an associated beam offset, based on the determined horizontal step size.

The WTRU may report the determined beams for the multiple CSI-RS resources. The report may comprise legacy beam indices in the vertical and horizontal directions for the ordered set of reference beams. The report may comprise an indication of the determined beam offset step size(s). The report may comprise ordered sets of beam offsets in the vertical and horizontal directions for the non-reference CSI-RS resources.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media (which do not include transitory signals). Examples of computer-readable storage media, which are differentiated from signals, may include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, network node, base station, RNC, or any host computer.

Any of the operations, processes, etc. described herein may be implemented as computer-readable instructions stored on a computer-readable storage medium. The computer-readable instructions may be executed by a processor of a mobile unit, a network element, and/or any other computing device.

What is claimed is:

1. A wireless transmit/receive unit (WTRU) comprising:
a transceiver; and
a processor configured to:
receive, via the transceiver, configuration information, wherein the configuration information comprises an indication of a set of resources, wherein the set of resources comprises a reference resource and one or more non-reference resources, wherein the configuration information comprises at least one codebook associated with the set of resources, and wherein the configuration information comprises a set of beam offset parameters for differential beam reporting;
receive, via the transceiver, the set of resources;
determine at least one set of beam offset values from the set of beam offset parameters;
based on the received set of resources:
determine a reference beam for the received reference resource based on the received at least one codebook; and
determine respective non-reference beams for each of the non-reference resources based on the received at least one codebook; and
send, via the transceiver, a report, wherein the report comprises an indication of the reference beam comprising beam indices in a first dimension and a second dimension associated with the reference resource, wherein the report comprises respective beam offset values, based on the at least one set of beam offset values, in the first dimension and the second dimension for the received non-reference resources, and wherein the report comprises an indication of respective beams for the non-reference resources based on beam indices associated with the reference resource and respective offset values.

2. The WTRU of claim 1, wherein:
the set of resources comprises a set of channel state information reference signal (CSI-RS) resources;
the reference resource comprises a reference CSI-RS resource; and
the one or more non-reference resources comprises one or more non-reference CSI-RS resources.

3. The WTRU of claim 1, wherein:
the at least one codebook comprises a first codebook associated with the reference resource and a second codebook associated with the non-reference resources;
the processor is configured to determine a reference beam for the received reference resource based on the first codebook; and
the processor is configured to determine the respective non-reference beams for the received reference resource based on the second codebook.

4. The WTRU of claim 1, wherein the set of beam offset parameters comprises a plurality of beam offset values and wherein the processor is configured to determine the at least one set of beam offset values based on the plurality of beam offset values.

5. The WTRU of claim 1, wherein:
the set of beam offset parameters comprises a set of beam offset step sizes;
the processor is configured to determine a beam offset step size based on the set of beam offset step sizes;
the processor is configured to determine the at least one set of beam offset values based on the set of beam offset step sizes, wherein beam offset values are separated by the determined beam offset step size; and
the report comprises an indication of the determined beam offset step size.

6. The WTRU of claim 1, wherein:
the set of beam offset parameters comprises a plurality of sets of beam offset values;
the processor is configured to determine the at least one set of beam offset values based on the plurality of sets of beam offset values; and
the report comprises an indication of the determined at least one set of beam offset values.

7. The WTRU of claim 1, wherein:
the at least one set of beam offset values comprises a first set of beam offset values associated with the first dimension and a second set of beam offset values associated with the second dimension; and
the report comprises respective beam offset values in the first dimension based on the first set of beam offset values and beam offset values in the second dimension based on the second set of beam offset values for the received non-reference resources.

8. The WTRU of claim 1, wherein the configuration information further comprises a two-dimensional (2D) relationship between the received set of resources in the first dimension.

9. The WTRU of claim 1, wherein the processor is configured to:
order the received set of resources in a two-dimensional (2D) grid; and
determine a 2D relationship between the received set of resources based on the 2D grid.

10. The WTRU of claim 1, wherein the processor is configured to determine a beam in the first dimension for the reference resource and a beam in the first dimension for the non-reference resource.

11. A method performed by a wireless transmit/receive unit (WTRU), the method comprising:
receiving configuration information, wherein the configuration information comprises an indication of a set of resources, wherein the set of resources comprises a reference resource and one or more non-reference resources, wherein the configuration information comprises at least one codebook associated with the set of resources, and wherein the configuration information comprises a set of beam offset parameters for differential beam reporting;
receiving the set of resources;
determining at least one set of beam offset values from the set of beam offset parameters;
based on the received set of resources:
determining a reference beam for the received reference resource based on the received at least one codebook; and
determining respective non-reference beams for each of the non-reference resources based on the received at least one codebook; and
sending a report, wherein the report comprises an indication of the reference beam comprising beam indices in a first dimension and a second dimension associated with the reference resource, wherein the report comprises respective beam offset values, based on the at least one set of beam offset values, in the first dimension and the second dimension for the received non-reference resources, and wherein the report comprises an indication of respective beams for the non-reference resources based on beam indices associated with the reference resource and respective offset values.

12. The method of claim 11, wherein:
the set of resources comprises a set of channel state information reference signal (CSI-RS) resources;
the reference resource comprises a reference CSI-RS resource; and
the one or more non-reference resources comprises one or more non-reference CSI-RS resources.

13. The method of claim 11, wherein the at least one codebook comprises a first codebook associated with the reference resource and a second codebook associated with the non-reference resources, the method further comprising:
determining a reference beam for the received reference resource based on the first codebook; and
determining the respective non-reference beams for the received reference resource based on the second codebook.

14. The method of claim 11, wherein the set of beam offset parameters comprises a plurality of beam offset values, the method further comprising determining the at least one set of beam offset value based on the plurality of beam offset values.

15. The method of claim 11, wherein the set of beam offset parameters comprises a set of beam offset step sizes, the method further comprising:
determining a beam offset step size based on the set of beam offset step sizes; and
determining the at least one set of beam offset values based on the set of beam offset step sizes, wherein beam offset values are separated by the determined beam offset step size, and wherein the report comprises an indication of the determined beam offset step size.

16. The method of claim 11, wherein the set of beam offset parameters comprises a plurality of sets of beam offset values, the method further comprising determining the at least one set of beam offset values based on the plurality of sets of beam offset values, wherein the report comprises an indication of the determined at least one set of beam offset values.

17. The method of claim 11, wherein:
the at least one set of beam offset values comprises a first set of beam offset values associated with the first dimension and a second set of beam offset values associated with the second dimension; and
the report comprises respective beam offset values in the first dimension based on the first set of beam offset values and beam offset values in the second dimension based on the second set of beam offset values for the received non-reference resources.

18. The method of claim 11, wherein the configuration information further comprises a two-dimensional (2D) relationship between the received set of resources in the first dimension.

19. The method of claim 11, further comprising:
ordering the received set of resources in a two-dimensional (2D) grid; and
determining a 2D relationship between the received set of resources based on the 2D grid.

20. The method of claim 11, further comprising determining a beam in the first dimension for the reference resource and a beam in the first dimension for the non-reference resource.
